(19) United States
(12) Patent Application Publication
(10) Pub. No.: US 2022/0149660 A1
(43) Pub. Date: May 12, 2022

(54) WIRELESS POWER SUPPLY UNIT AND POWER RECEPTION MODULE

(71) Applicant: Panasonic Intellectual Property Management Co., Ltd., Osaka (JP)

(72) Inventors: Hideaki MIYAMOTO, Osaka (JP); Tsutomu SAKATA, Osaka (JP); Minoru OKADA, Nara (JP); Takeshi HIGASHINO, Nara (JP); Quang Thang DUONG, Nara (JP); Shudai KAWAI, Nara (JP)

(21) Appl. No.: 17/433,744

(22) PCT Filed: Feb. 26, 2020
(86) PCT No.: PCT/JP2020/007861

§ 371 Date: Aug. 25, 2021

(30) Foreign Application Priority Data
Feb. 27, 2019 (JP) 2019-033741

(51) Int. Cl. H02J 50/12; H02J 50/40; H01F 38/14; H02J 50/70

(52) U.S. Cl. CPC H02J 50/12; H02J 50/402; H01F 2038/143; H02J 50/70; H01F 38/14

(57) ABSTRACT

The operation of a wireless power transmission system is to be stabilized. A wireless power supply unit includes a power transmitting module and a power receiving module. The power transmitting module includes a transmission coil to send out AC power. The power receiving module includes: a reception coil to receive from the transmission coil at least a portion of the AC power; and a compensation circuit connected to the reception coil, the compensation circuit including at least one compensation element to counteract at least a part of a leakage reactance or an excitation reactance of a coil pair including the transmission coil and the reception coil.

### TECHNICAL FIELD

The present disclosure relates to a wireless power supply unit and a power receiving module.

### BACKGROUND ART

In the recent years, wireless power transmission techniques for transmitting electric power in a wireless (contactless) manner have been being developed.

Patent Document 1 discloses an example of a contactless power supplying apparatus which contactlessly supplies power to a movable unit or an electric device. In the contactless power supplying apparatus disclosed in Patent Document 1, electric power is transmitted from a primary winding to a secondary winding by electromagnetic induction action. A series capacitor is connected to one of the primary winding and the secondary winding, while a parallel capacitor is connected to the other of the primary winding and the secondary winding. The respective capacitance values of the series capacitor and the parallel capacitor are set so that the transformer in the contactless power supplying apparatus will be substantially equivalent to an ideal transformer. It is stated that such a setting realizes a contactless power supplying apparatus with a high efficiency, a high power factor, and independence from load variation.

Patent Document 2 discloses a contactless power supplying apparatus which includes two sets of coils, each including a coil for power transmission purposes and a coil for power reception purposes. In the contactless power supplying apparatus disclosed in Patent Document 2, electric power is contactlessly transmitted from two primary coils disposed in a stationary section to two secondary coils disposed in a rotary section.

### CITATION LIST

### Patent Literature

[Patent Document 1] the specification of International Publication No. 2007/029438

[Patent Document 2] the specification of International Publication No. 2015/019478

### SUMMARY OF INVENTION

### Technical Problem

The present disclosure provides a technique for further stabilizing the operation of a wireless power transmission system.

### Solution to Problem

A wireless power supply unit according to one implementation of the present disclosure includes a power transmitting module and a power receiving module. The power transmitting module includes a transmission coil to send out AC power. The power receiving module includes: a reception coil to receive from the transmission coil at least a portion of the AC power; and a compensation circuit connected to the reception coil. The compensation circuit includes at least one compensation element to counteract at least a part of a leakage reactance or an excitation reactance of a coil pair comprising the transmission coil and the reception coil.

A wireless power supply unit according to another implementation of the present disclosure includes a power transmitting module and a power receiving module. The power transmitting module includes a first transmission coil to send out first AC power and a second transmission coil to send out second AC power. The power receiving module includes: a first reception coil to receive from the first transmission coil at least a portion of the first AC power; a second reception coil to receive from the second transmission coil at least a portion of the second AC power; and a compensation circuit connected to the first and second reception coils. The compensation circuit includes at least one compensation element to counteract at least a part of a leakage reactance or an excitation reactance of at least one coil pair among: a first coil pair comprising the first transmission coil and the first reception coil, a second coil pair comprising the second transmission coil and the second reception coil, a third coil pair comprising the first transmission coil and the second transmission coil, a fourth coil pair comprising the first reception coil and the second reception coil, a fifth coil pair comprising the first transmission coil and the second reception coil, and a sixth coil pair comprising the second transmission coil and the first reception coil.

General or specific aspects of the present disclosure may be implemented using an apparatus, a system, a method, an integrated circuit, a computer program, or a storage medium, or any combination of an apparatus, a system, a method, an integrated circuit, a computer program, and/or a storage medium.

### Advantageous Effects of Invention

According to one implementation of the present disclosure, the operation of a wireless power transmission system can be further stabilized.

### BRIEF DESCRIPTION OF DRAWINGS

FIG. 1 A block diagram showing an exemplary configuration of a wireless power transmission system.

FIG. 2A A diagram showing a circuit configuration used for analysis.

FIG. 2B A diagram showing a circuit configuration used for analysis.

FIG. 3 A diagram schematically showing the configuration of a wireless power transmission system according to illustrative Embodiment 1 of the present disclosure.

FIG. 4 A diagram showing equivalent circuits of a coupled circuit and a compensation circuit.

FIG. 5 A diagram schematically showing electromagnetic coupling between coils in the coupled circuit.

FIG. 6 A diagrams showing a n equivalent circuit of the coupled circuit.

FIG. 7 A diagram showing an exemplary arrangement of a plurality of compensation elements.

FIG. 8 A diagram showing an example of a specific configuration of the coupled circuit and the compensation circuit.

FIG. 9 A diagram showing a first variant of Embodiment 1.

FIG. 10 A diagram showing a second variant of Embodiment 1.

FIG. 11 A diagram showing a third variant of Embodiment 1.

FIG. 12 A diagram showing a fourth variant of Embodiment 1.

FIG. 13 A diagram showing a fifth variant of Embodiment 1.

FIG. 14 A diagram showing the configuration of illustrative Embodiment 2 of the present disclosure in outline.

FIG. 15 A diagram showing an example of a specific configuration of a coupled circuit and a compensation circuit in Embodiment 2.

FIG. 16 A graph showing results of analysis of transient variation of an output voltage Vout1 under a varying load RL1.

FIG. 17 A diagram showing a variant of Embodiment 2.

FIG. 18 A diagram showing example waveforms of Vin1 and Vin2 in the cases where the phase difference between Vin1 and Vin2 is 0°, 90° and 180°.

FIG. 19 A diagram illustrating that changing the phase difference between Vin1 and Vin2 allows Vout1 and Vout2 to be changed.

FIG. 20 A diagram schematically showing the configuration of a wireless power transmission system according to illustrative Embodiment 3 of the present disclosure.

FIG. 21 A diagram showing a coupled circuit in Embodiment 3 in a n equivalent circuit.

FIG. 22 A diagram showing an example of a robot arm apparatus in which wireless power transmission is applied.

FIG. 23 A block diagram showing an exemplary configuration of the wireless power transmission system.

FIG. 24A A diagram showing an exemplary equivalent circuit of a transmission coil and a reception coil.

FIG. 24B A diagram showing another exemplary equivalent circuit of a transmission coil and a reception coil.

FIG. 25A A diagram showing exemplary relative positions of transmission coils and reception coils.

FIG. 25B A diagram showing other exemplary relative positions of transmission coils and reception coils.

FIG. 25C A diagram showing still other exemplary relative positions of transmission coils and reception coils.

FIG. 26 A perspective view showing another exemplary arrangement of coils in a linear motion section of an arm.

FIG. 27A A diagram showing an exemplary configuration of a full-bridge type inverter circuit.

FIG. 27B A diagram showing an exemplary configuration of a half-bridge type inverter circuit.

### DESCRIPTION OF EMBODIMENTS

(Findings Providing the Basis of the Present Disclosure)

Prior to describing embodiments of the present disclosure, findings providing the basis of the present disclosure will be described.

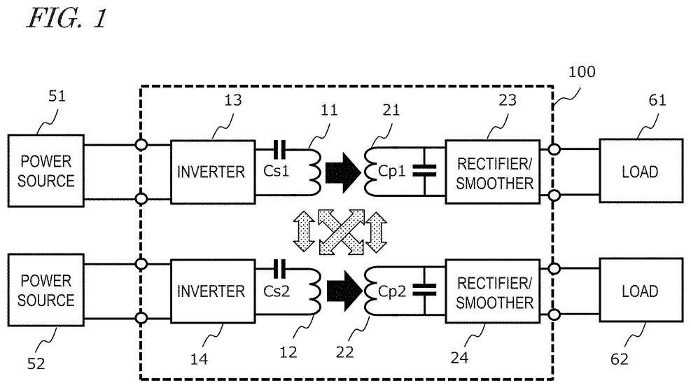

FIG. 1 is a block diagram showing an exemplary configuration of a wireless power transmission system. This wireless power transmission system includes a wireless power supply unit 100, a first power source 51, a second power source 52, a first load 61, and a second load 62. The wireless power supply unit 100 is connected to two power sources 51 and 52 and two loads 61 and 62. The wireless power supply unit 100 allows electric power which is supplied from the power sources 51 and 52 to be wirelessly supplied to the loads 61 and 62, respectively. In other words, the wireless power supply unit 100 includes two wireless power transmission subsystems. Hereinafter, these two wireless power transmission subsystems will be referred to as a “first subsystem” and a “second subsystem”.

The first subsystem includes a first inverter circuit 13, a first transmission coil 11, a first reception coil 21, and a first rectifier circuit 23. The second subsystem includes a second inverter circuit 14, a second transmission coil 12, a second reception coil 22, and a second rectifier circuit 24. Wireless power transmission in the first subsystem is realized by electromagnetic coupling between the first transmission coil 11 and the first reception coil 21 opposed thereto. Wireless power transmission in the second subsystem is realized by electromagnetic coupling between the second transmission coil 12 and the second reception coil 22 opposed thereto.

The first inverter circuit 13 is connected between the first power source 51 and the first transmission coil 11. The first inverter circuit 13 converts first DC power, which is output from the first power source 51, into first AC power and supplies the first AC power to the first transmission coil 12. The second inverter circuit 14 is connected between the second power source 52 and the second transmission coil 12. The second inverter circuit 14 converts second DC power, which is output from the second power source 52, into second AC power and supplies the second AC power to the second transmission coil 12.

The first rectifier circuit 23 is connected between the first reception coil 21 and the first load 61. The first rectifier circuit 23 rectifies and smoothens the AC power received by the first reception coil 21, and supplies it to the first load 61. The second rectifier circuit 24 is connected between the second reception coil 22 and the second load 62. The second rectifier circuit 24 rectifies and smoothens the AC power received by the second reception coil 22, and supplies it to the second load 62.

The system shown in FIG. 1 may be used for the purpose of supplying electric power, each independently, to an electric device such as a motor that is included in a robot and a control device for controlling the electric device, for example. In that case, the electric device such as a motor corresponds to the first load 61, and the control device controlling the electric device corresponds to the second load 62.

In the present specification, a “load” means any device that may operate with electric power. Examples of “loads” include devices such as motors, cameras, imaging devices, light sources, secondary batteries, and electronic circuits (e.g., power conversion circuits or microcontrollers).

In the example shown in FIG. 1, capacitors Cs1 and Cs2 are connected in series to the transmission coils 11 and 12, respectively, whereas capacitors Cp1 and Cp2 are connected in parallel to the reception coils 21 and 22, respectively. In other words, in each subsystem, a series capacitor is disposed on the power transmission side, and a parallel capacitor is disposed on the power reception side. This configuration is similar to the configuration disclosed in Patent Document 1. Hereinafter, the reference numeral representing each capacitor (e.g., Cs1) is also used as a symbol indicating the capacitance value of that capacitor.

According to the description of Patent Document 1, the capacitance value of each capacitor is set so that a transformer which is constituted by a pair consisting of a transmission coil and a reception coil is substantially equivalent to an ideal transformer. Such settings are expected to provide a system with a high efficiency, a high power factor, or independence from load variation.

However, according to a study by the inventors, when the coil pairs of a plurality of subsystems are disposed within the same unit, setting the respective capacitance values as above does not achieve an adequate performance. This is presumably because of unwanted electromagnetic coupling occurring between the coils of the plurality of subsystems.

In the example of FIG. 1, not only the necessary inter-coil coupling represented by dark arrows, but also some unwanted inter-coil coupling occurs as indicated by dotted arrows. Unwanted inter-coil coupling occurs between the first transmission coil 11 and the second transmission coil 12, the first transmission coil 11 and the second reception coil 22, between the second transmission coil 12 and the first reception coil 21, and between the first reception coil 21 and the second reception coil 22. These instances of unwanted coupling may give rise to the following problems, for example.

Output voltage variation: a part of the electric power that is transmitted in each subsystem may leak to the respective other subsystem, thus causing variation in the output voltage from each subsystem.

Unwanted operation when the load is stopped: when power supply to the first load is suspended, a part of the electric power supplied to the second load may leak to the first subsystem, thus causing unwanted operation of the first load.

Such problems may similarly occur in a system where wireless power transmission takes place in three or more subsystems.

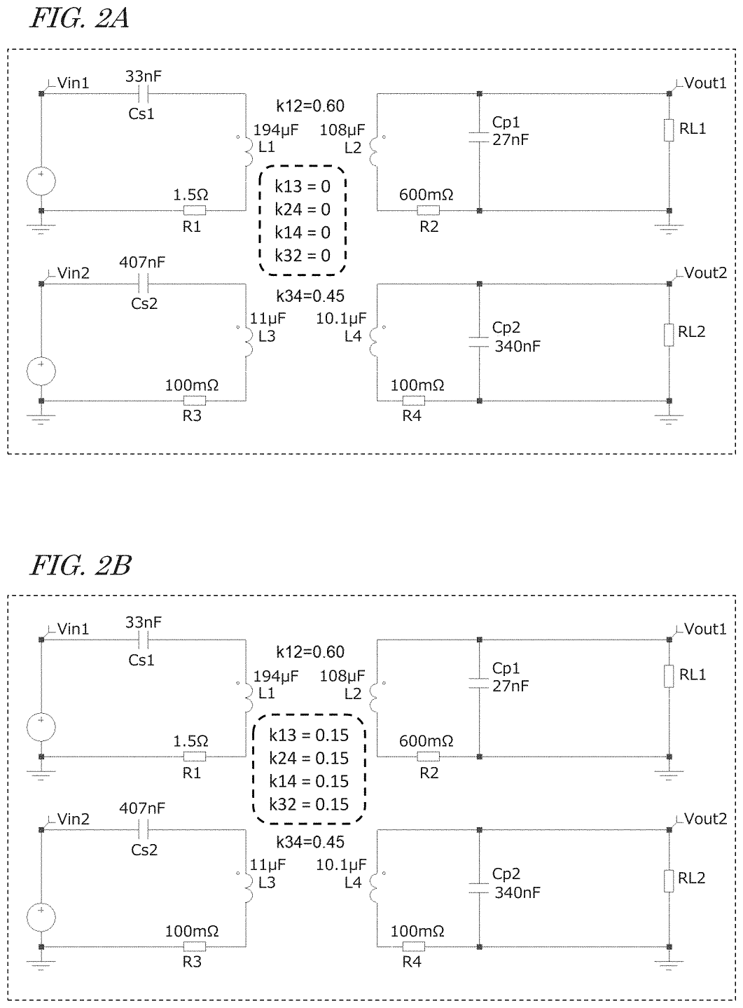

The inventors have performed a circuit analysis for the configuration shown in FIG. 1 to check the influences of unwanted inter-coil coupling on power transmission. FIG. 2A is a diagram showing the circuit configuration used in this analysis. In the first subsystem, a series capacitor Cs1 is connected to a transmission coil L1, whereas a parallel capacitor Cp1 is connected to a reception coil L2. In the second subsystem, a series capacitor Cs2 is connected to a transmission coil L3, whereas a parallel capacitor Cp2 is connected to a reception coil L4. In FIG. 2A, R1, R2, R3 and R4 respectively represent resistance components of the coils L1, L2, L3 and L4. An input voltage of a series resonant circuit that is constituted by the transmission coil L1, the series capacitor Cs1, and the resistor R1 is denoted as Vin1. An output voltage of a parallel resonant circuit that is constituted by the reception coil L2, the parallel capacitor Cp1, and the resistor R2 is denoted as Vout1. The voltage Vout1 is applied to the load RL1. Similarly, an output voltage of a parallel resonant circuit that is constituted by the reception coil L4, the parallel capacitor Cp2, and the resistor R4 is denoted as Vout2. The voltage Vout2 is applied to the load RL2. A coupling coefficient between the coils L1 and L2 is denoted as k12; a coupling coefficient between the coils L3 and L4 is denoted as k34; a coupling coefficient between the coils L1 and L4 is denoted as k14; a coupling coefficient between the coils L3 and L2 is denoted as k32; and a coupling coefficient between the coils L2 and L4 is denoted as k24.

FIG. 2A shows an example where there is no unwanted coupling between the subsystems, i.e., k13=k24=k14=k32=0. The other circuit parameters are as shown in the figure.

Table 1 shows change in Vout1 and Vout2 in the case where the input voltages are set to Vin1=255 V, Vin2=12 V, with the values of RL1 and RL2 being varied. Herein, rated voltages for the output voltages Vout1 and Vout2 are 282 V and 24 V, respectively.

TABLE 1

| | | | Rate of | | Rate of |
|---|---|---|---|---|---|
| | | | Variation | | Variation |
| RL1 | RL2 | Vout1 | (Vout1- | Vout2 | (Vout2- |
| [Ω] | [Ω] | [V] | 282)/282 | [V] | 24)/24 |
| 8000 | 140 | 303.8 | 7.7% | 25.4 | 5.7% |
| 110 | 140 | 293.5 | 4.1% | 25.4 | 5.7% |
| 35 | 140 | 262.3 | −7.0% | 25.4 | 5.7% |
| 8000 | 20 | 303.8 | 7.7% | 24.8 | 3.2% |
| 110 | 20 | 293.5 | 4.1% | 24.8 | 3.2% |
| 35 | 20 | 262.3 | −7.0% | 24.8 | 3.2% |
| 8000 | 7 | 303.8 | 7.7% | 23.5 | −1.9% |
| 110 | 7 | 293.5 | 4.1% | 23.5 | −1.9% |
| 35 | 7 | 262.3 | −7.0% | 23.5 | −1.9% |

Table 2 shows change in Vout1 and Vout2 in the case where the input voltages are set to Vin1=0 V, Vin2=12 V.

TABLE 2

| | | | Rate of | | Rate of |
|---|---|---|---|---|---|
| | | | Variation | | Variation |
| RL1 | RL2 | Vout1 | Vout1/ | Vout2 | (Vout2- |
| [Ω] | [Ω] | [V] | 282 | [V] | 24)/24 |
| 8000 | 140 | 0.0 | 0.0% | 25.4 | 5.7% |
| 8000 | 20 | 0.0 | 0.0% | 24.8 | 3.2% |
| 8000 | 7 | 0.0 | 0.0% | 23.5 | −1.9% |

Table 3 shows change in Vout1 and Vout2 in the case where the input voltages are set to Vin1=255 V, Vin2=0 V.

TABLE 3

| | | | Rate of | | Rate of |
|---|---|---|---|---|---|
| | | | Variation | | Variation |
| RL1 | RL2 | Vout1 | (Vout1- | | Vout2/ |
| [Ω] | [Ω] | [V] | 282)/282 | Vout2 | 24 |
| 8000 | 140 | 303.8 | 7.7% | 0.0 | 0.0% |
| 110 | 140 | 293.5 | 4.1% | 0.0 | 0.0% |
| 35 | 140 | 262.3 | −7.0% | 0.0 | 0.0% |

As shown in Table 1 to Table 3, the rates of variation from the respective optimum values of Vout1 and Vout2 are within 10%. Thus, in the absence of unwanted coupling between the subsystems, no interference between the subsystems occurs, and the output voltages are stable.

FIG. 2B shows a configuration in which the respective values of coupling coefficients k13, k24, k14 and k32 are increased to 0.15, up from the configuration of FIG. 2A. The other parameters are identical to those in FIG. 2A. In this case, some unwanted interference occurs between the subsystems.

Table 4 shows change in Vout1 and Vout2 in the case where, in the example of FIG. 2B, the input voltages are set to Vin1=255 V, Vin2=12 V, with the values of RL1 and RL2 being varied.

TABLE 4

| | | | Rate of | | Rate of |
|---|---|---|---|---|---|
| | | | Variation | | Variation |
| RL1 | RL2 | Vout1 | (Vout1- | | (Vout2-24)/ |
| [Ω] | [Ω] | [V] | 282)/282 | Vout2 | 24 |
| 8000 | 140 | 304.3 | 7.9% | 4.3 | −82.3% |
| 110 | 140 | 293.7 | 4.2% | 7.4 | −69.2% |
| 35 | 140 | 263.2 | −6.6% | 14.0 | −41.6% |
| 8000 | 20 | 304.2 | 7.9% | 4.1 | −82.8% |
| 110 | 20 | 293.5 | 4.1% | 7.2 | −70.0% |
| 35 | 20 | 262.6 | −6.9% | 13.6 | −43.3% |
| 8000 | 7 | 304.0 | 7.8% | 3.9 | −83.7% |
| 110 | 7 | 292.9 | 3.9% | 6.8 | −71.6% |
| 35 | 7 | 261.4 | −7.3% | 12.8 | −46.5% |

Table 5 shows change in Vout1 and Vout2 in the case where the input voltages are set to Vin1=0 V, Vin2=12 V.

TABLE 5

| | | | Rate of | | Rate of |
|---|---|---|---|---|---|
| | | | Variation | | Variation |
| RL1 | RL2 | Vout1 | Vout1/ | | (Vout2- |
| [Ω] | [Ω] | [V] | 282 | Vout2 | 24)/24 |
| 8000 | 140 | 6.0 | 2.1% | 27.0 | 12.6% |
| 8000 | 20 | 6.3 | 2.2% | 26.3 | 9.7% |
| 8000 | 7 | 7.8 | 2.8% | 24.9 | 3.9% |

Table 6 shows change in Vout1 and Vout2 in the case where the input voltages are set to Vin1=255 V, Vin2=0 V.

TABLE 6

| | | | Rate of | | Rate of |
|---|---|---|---|---|---|
| | | | Variation | | Variation |
| RL1 | RL2 | Vout1 | (Vout1- | | Vout2/ |
| [Ω] | [Ω] | [V] | 282)/282 | Vout2 | 24 |
| 8000 | 140 | 309.5 | 9.8% | 20.7 | 86.4% |
| 110 | 140 | 298.8 | 6.0% | 21.2 | 88.4% |
| 35 | 140 | 267.8 | −5.0% | 25.7 | 107.1% |

From the results of Table 4, it can be seen that interference from the first subsystem to the second subsystem is large, and that Vout2 greatly deviates from the rated voltage of 24 V. As shown in Table 5 and Table 6, even when one subsystem is stopped, the output voltage of the other subsystem is greater than 0, indicative of an unintended operation of the load.

Thus, in a system where a plurality of coil pairs which wirelessly transmit electric power are close together, unwanted coupling between the coils may result in great variation in the output voltages, possibly causing an unintended operation of the loads.

Based on the above thoughts, the inventors have sought for a configuration for solving the aforementioned problems. The inventors have found that the aforementioned problems can be solved by providing a compensation circuit to counteract at least a part of a leakage reactance and an excitation reactance of each coil pair after the respective reception coil. Hereinafter, embodiments of the present disclosure will be described in outline.

A wireless power supply unit according to one implementation of the present disclosure includes a power transmitting module and a power receiving module. The power transmitting module includes a first transmission coil to send out first AC power and a second transmission coil to send out second AC power. The power receiving module includes: a first reception coil to receive from the first transmission coil at least a portion of the first AC power; a second reception coil to receive from the second transmission coil at least a portion of the second AC power; and a compensation circuit connected to the first and second reception coils. The compensation circuit includes at least one compensation element to counteract at least a part of a leakage reactance or an excitation reactance of at least one coil pair among: a first coil pair comprising the first transmission coil and the first reception coil, a second coil pair comprising the second transmission coil and the second reception coil, a third coil pair comprising the first transmission coil and the second transmission coil, a fourth coil pair comprising the first reception coil and the second reception coil, a fifth coil pair comprising the first transmission coil and the second reception coil, and a sixth coil pair comprising the second transmission coil and the first reception coil.

With the above configuration, because at least one compensation element is provided to counteract at least a part of a leakage reactance or an excitation reactance of at least one coil pair, interference based on electromagnetic coupling between the two subsystems can be suppressed.

In a wireless power transmission system, it is required to reduce the load dependence of output voltages. This aspect is a problem that is common to wireless power transmission systems, regardless of whether there is a single subsystem or multiple subsystems of power transmission. With the above configuration, dependence of the output voltage from each subsystem on load variation can be reduced.

The at least one compensation element may be configured to counteract a part or a whole of the leakage reactance and the excitation reactance of the at least one coil pair. It is not required for the compensation circuit to counteract all of the leakage reactance and the excitation reactance of each coil pair. An effect of stabilization of output voltages can be obtained even in a configuration in which only a part of such reactances is counteracted.

The compensation circuit may include a plurality of compensation elements to counteract both the excitation reactance and the leakage reactance of the at least one coil pair.

The compensation circuit may include a plurality of compensation elements to counteract at least a part of the leakage reactance or the excitation reactance of each of the first to sixth coil pairs.

The compensation circuit may include a plurality of compensation elements to counteract both of the leakage reactance and the excitation reactance of each of the first to sixth coil pairs.

When a coupled circuit including a plurality of coils that electromagnetically couple to one another is expressed in a n equivalent circuit, the plurality of coils including the first and second transmission coils and the first and second reception coils, a reactance value of each compensation element may be set to a value for counteracting one of a plurality of reactances in the n equivalent circuit.

The compensation circuit may include a first compensation element to counteract at least a part of the leakage reactance of the first coil pair, the first compensation element being connected in series to the first reception coil, and a second compensation element to counteract at least a part of the leakage reactance of the second coil pair, the second compensation element being connected in series to the second reception coil.

The power transmitting module may include: a third compensation element connected in series to the first transmission coil; and a fourth compensation element connected in series to the second transmission coil. The first compensation element and the third compensation element may be designed so as to counteract the leakage reactance of the first coil pair. The second compensation element and the fourth compensation element may be designed so as to counteract the leakage reactance of the second coil pair.

The at least one compensation element may be a capacitor or an inductor.

The power transmitting module may include a first inverter circuit to supply the first AC power to the first transmission coil, a second inverter circuit to supply the second AC power to the second transmission coil, and a control circuit to control the first and second inverter circuits.

The control circuit may be configured to change voltages to be output from the compensation circuit by changing a phase difference between the first AC power and the second AC power.

The power transmitting module may further include a third transmission coil to send out third AC power. The power receiving module may further include a third reception coil to receive from the third transmission coil at least a portion of the third AC power. The compensation circuit may include at least one compensation element to counteract at least a part of a leakage reactance or an excitation reactance of a coil pair comprising: one coil among the first and second transmission coils and the first and second reception coils; and the third transmission coil or the third reception coil.

A wireless power supply unit according to the present disclosure may not necessarily include a plurality of power transmission subsystems. In other words, the wireless power supply unit may include only one pair comprising a transmission coil and a reception coil.

A wireless power supply unit according to another implementation of the present disclosure includes a power transmitting module and a power receiving module. The power transmitting module includes a transmission coil to send out AC power. The power receiving module includes a reception coil to receive from the transmission coil at least a portion of the AC power, and a compensation circuit connected to the reception coil. The compensation circuit includes at least one compensation element to counteract at least a part of a leakage reactance or an excitation reactance of a coil pair comprising the transmission coil and the reception coil.

In accordance with the above configuration, by providing a compensation circuit, load dependence of output voltages can be reduced.

Hereinafter, more specific embodiments of the present disclosure will be described. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, identical or similar component elements are denoted by identical reference numerals.

### Embodiment 1

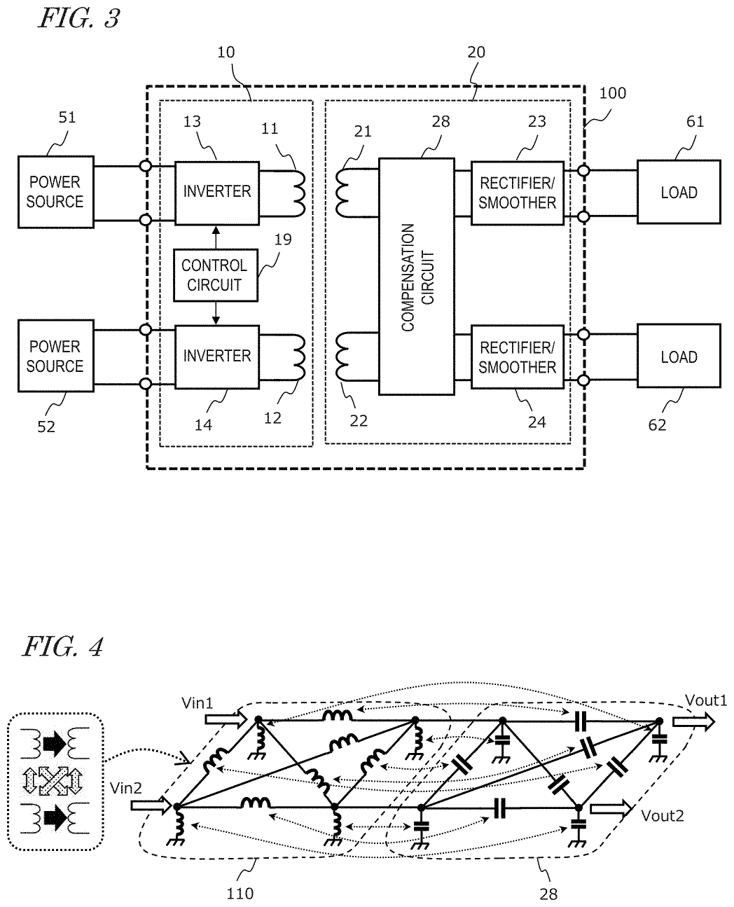

FIG. 3 is a diagram showing schematically showing the configuration of a wireless power transmission system according to illustrative Embodiment 1 of the present disclosure. Except for the configuration of the wireless power supply unit 100, this wireless power transmission system is similar in configuration to the system shown in FIG. 1. Hereinafter, an exemplary configuration of the wireless power supply unit 100 according to the present embodiment will be described.

The wireless power supply unit 100 includes a power transmitting module 10 and a power receiving module 20. The power transmitting module 10 includes a first transmission coil 11, a first inverter circuit 13, a second transmission coil 12, a second inverter circuit 14, and a control circuit 19. The first transmission coil 11 is connected to the first inverter circuit 13. The second transmission coil 12 is connected to the second inverter circuit 14. The control circuit 19 controls the first inverter circuit 13 and the second inverter circuit 14.

The power receiving module 20 includes a first reception coil 21, a first rectifier circuit 23, a second reception coil 22, a second rectifier circuit 24, and a reactance compensation circuit 28. The reactance compensation circuit 28 is connected to the reception coils 21 and 22. The compensation circuit 28 includes a plurality of compensation elements. Each compensation element is a capacitor or an inductor.

FIG. 4 is a diagram showing an equivalent circuit of a coupled circuit 110 that is constituted by the transmission coils 11 and 12 and the reception coils 21 and 22 and an equivalent circuit of the compensation circuit 28. In FIG. 4, the coupled circuit constituted by the coil pairs of the two subsystems is expressed as a n equivalent circuit. The compensation circuit 28 includes a plurality of compensation elements. In the example of FIG. 4, each compensation element is a capacitor. The plurality of compensation elements are designed so as to counteract the leakage reactances and excitation reactances between the four coils 11, 12, 21 and 22. With such a configuration, the input-output impedance in each subsystem can be made substantially zero. Therefore, irrespectively of the states of the loads 61 and 62, the input voltage Vin1 and the output voltage Vout1 can be substantially matched, and the input voltage Vin2 and the output voltage Vout2 can be substantially matched. As a result, mutual interference between the two subsystems can be reduced, and the load dependence of the output voltage in each subsystem can be reduced.

Now, an example of a method of determining the reactance value of each compensation element will be described.

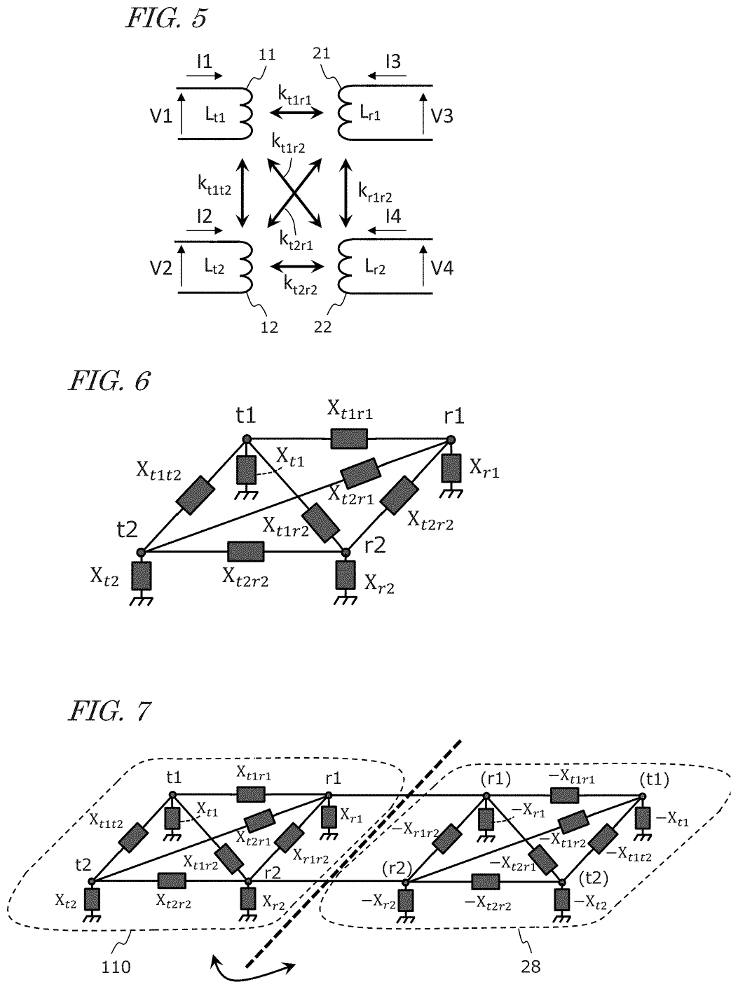

FIG. 5 is a diagram schematically showing electromagnetic coupling in the coupled circuit 110 constituted by the coils 11, 12, 21 and 22. In this coupled circuit, a self-inductance of each coil and a coupling coefficient and a mutual inductance associated with each coil pair are represented by the following symbols.

<Self-Inductances>

self-inductance of transmission coil 11: Lₜ₁

self-inductance of transmission coil 12: Lₜ₂

self-inductance of reception coil 21: Lᵣ₁

self-inductance of reception coil 22: Lᵣ₂

<Coupling Coefficients>

coupling coefficient between transmission coil 11 and reception coil 21: kₜ₁ᵣ₁

coupling coefficient between transmission coil 11 and transmission coil 12: kₜ₁ₜ₂

coupling coefficient between transmission coil 11 and reception coil 22: kₜ₁ᵣ₂

coupling coefficient between transmission coil 12 and reception coil 21: kₜ₂ᵣ₁

coupling coefficient between transmission coil 12 and reception coil 22: kₜ₂ᵣ₂

coupling coefficient between reception coil 21 and reception coil 22: kᵣ₁ᵣ₂

<Mutual Inductances>

mutual inductance between transmission coil 11 and reception coil 21:

Mₜ₁ᵣ₁=kₜ₁ᵣ₁√(Lₜ₁·Lᵣ₁)

mutual inductance between transmission coil 11 and transmission coil 12:

Mₜ₁ₜ₂=kₜ₁ₜ₂√(Lₜ₁·Lₜ₂)

mutual inductance between transmission coil 11 and reception coil 22:

Mₜ₁ᵣ₂=kₜ₁ᵣ₂√(Lₜ₁·Lᵣ₂)

mutual inductance between transmission coil 12 and reception coil 21:

Mₜ₂ᵣ₁₁=kₜ₁ᵣ₁√(Lₜ₁·Lᵣ₁)

mutual inductance between transmission coil 12 and reception coil 22:

Mₜ₂ᵣ₂=kₜ₂ᵣ₂√(Lₜ₂·Lᵣ₂)

mutual inductance between reception coil 21 and reception coil 22:

Mᵣ₁ᵣ₂=kᵣ₁ᵣ₂√(Lᵣ₁·Lᵣ₂)

If the coupling between the coils in this coupled circuit were to be expressed in a Z matrix, it would be expressed as eq. 1 below.

$$Z = j ω [ \begin{matrix}{L}_{t 1} & {M}_{t 1 t 2} & {M}_{t 1 r 1} & {M}_{t 1 r 2} \\ {M}_{t 1 t 2} & {L}_{t 2} & {M}_{t 2 r 1} & {M}_{t 2 r 2} \\ {M}_{t 1 r 1} & {M}_{t 2 r 1} & {L}_{r 1} & {M}_{r 1 r 2} \\ {M}_{t 1 r 2} & {M}_{t 2 r 2} & {M}_{r 1 r 2} & {L}_{r 2}\end{matrix} ] \qquad [ eq . 1 ]$$

As shown in FIG. 5, when voltages V1, V2, V3 and V4 and currents I1, I2, I3 and I4 are defined, and a vector V is defined as V=(V1 V2 V3 V4)^{T} and a vector I is defined as I=(I1 I2 I3 I4)^{T}, then the Z matrix is a matrix satisfying V=ZI.

As indicated in eq. 2 below, an ij component of the Z matrix is expressed as aᵢⱼ.

$$Z = j ω [ \begin{matrix}{L}_{t 1} & {M}_{t 1 t 2} & {M}_{t 1 r 1} & {M}_{t 1 r 2} \\ {M}_{t 1 t 2} & {L}_{t 2} & {M}_{t 2 r 1} & {M}_{t 2 r 2} \\ {M}_{t 1 r 1} & {M}_{t 2 r 1} & {L}_{r 1} & {M}_{r 1 r 2} \\ {M}_{t 1 r 2} & {M}_{t 2 r 2} & {M}_{r 1 r 2} & {L}_{r 2}\end{matrix} ] = j ω [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] \qquad [ eq . 2 ]$$

A Y matrix, i.e., an inverse matrix of the Z matrix, can be expressed by eq. 3 below.

$$Y = {Z}^{- 1} = \frac{- j}{ω} [ \begin{matrix}{A}_{11}^{- 1} & {A}_{12}^{- 1} & {A}_{13}^{- 1} & {A}_{14}^{- 1} \\ {A}_{21}^{- 1} & {A}_{22}^{- 1} & {A}_{23}^{- 1} & {A}_{24}^{- 1} \\ {A}_{31}^{- 1} & {A}_{32}^{- 1} & {A}_{33}^{- 1} & {A}_{34}^{- 1} \\ {A}_{41}^{- 1} & {A}_{42}^{- 1} & {A}_{43}^{- 1} & {A}_{44}^{- 1}\end{matrix} ] = \frac{j}{ω} [ \begin{matrix}{Y}_{t 1 t 1} & {Y}_{t 1 t 2} & {Y}_{t 1 r 1} & {Y}_{t 1 r 2} \\ {Y}_{t 2 t 1} & {Y}_{t 2 t 2} & {Y}_{t 2 r 1} & {Y}_{t 2 r 2} \\ {Y}_{r 1 t 1} & {Y}_{r 1 t 2} & {Y}_{r 1 r 1} & {Y}_{r 1 r 2} \\ {Y}_{r 2 t 1} & {Y}_{r 2 t 2} & {Y}_{r 2 r 1} & {Y}_{r 2 r 2}\end{matrix} ] \qquad [ eq . 3 ]$$

Each element in the matrix of eq. 3 is derived through the following calculation, by using determinant |A|.

$$\begin{matrix}\vert A \vert = {a}_{11} {a}_{22} {a}_{33} {a}_{44} + {a}_{11} {a}_{23} {a}_{34} {a}_{42} + {a}_{11} {a}_{24} {a}_{32} {a}_{43} - {a}_{11} {a}_{24} {a}_{33} {a}_{42} - {a}_{11} {a}_{23} {a}_{32} {a}_{44} - {a}_{11} {a}_{22} {a}_{34} {a}_{43} - {a}_{12} {a}_{21} {a}_{33} {a}_{44} - {a}_{13} {a}_{21} {a}_{34} {a}_{42} - {a}_{14} {a}_{21} {a}_{32} {a}_{43} + {a}_{14} {a}_{21} {a}_{33} {a}_{42} + {a}_{13} {a}_{21} {a}_{32} {a}_{44} + {a}_{12} {a}_{21} {a}_{34} {a}_{43} + {a}_{12} {a}_{23} {a}_{31} {a}_{44} + {a}_{13} {a}_{24} {a}_{31} {a}_{42} + {a}_{14} {a}_{22} {a}_{31} {a}_{43} - {a}_{14} {a}_{23} {a}_{31} {a}_{42} - {a}_{13} {a}_{22} {a}_{31} {a}_{44} - {a}_{12} {a}_{24} {a}_{31} {a}_{43} - {a}_{12} {a}_{23} {a}_{34} {a}_{41} - {a}_{13} {a}_{24} {a}_{32} {a}_{41} - {a}_{14} {a}_{22} {a}_{33} {a}_{41} + {a}_{14} {a}_{23} {a}_{32} {a}_{41} + {a}_{13} {a}_{22} {a}_{34} {a}_{41} + {a}_{12} {a}_{24} {a}_{33} {a}_{41} & [ eq . 4 ] \\ {A}_{11}^{- 1} = \frac{1}{\vert A \vert} ( {a}_{22} {a}_{33} {a}_{44} + {a}_{23} {a}_{34} {a}_{42} + {a}_{24} {a}_{32} {a}_{43} - {a}_{24} {a}_{33} {a}_{42} - {a}_{22} {a}_{32} {a}_{44} - {a}_{22} {a}_{34} {a}_{43} ) \\ {A}_{12}^{- 1} = \frac{1}{\vert A \vert} ( - {a}_{12} {a}_{33} {a}_{44} - {a}_{13} {a}_{34} {a}_{42} - {a}_{14} {a}_{32} {a}_{43} + {a}_{14} {a}_{33} {a}_{42} + {a}_{13} {a}_{32} {a}_{44} + {a}_{12} {a}_{34} {a}_{43} ) \\ {A}_{13}^{- 1} = \frac{1}{\vert A \vert} ( {a}_{12} {a}_{23} {a}_{44} + {a}_{13} {a}_{24} {a}_{42} + {a}_{14} {a}_{22} {a}_{43} - {a}_{14} {a}_{23} {a}_{42} - {a}_{13} {a}_{22} {a}_{44} - {a}_{12} {a}_{24} {a}_{43} ) \\ {A}_{14}^{- 1} = \frac{1}{\vert A \vert} ( - {a}_{12} {a}_{23} {a}_{34} - {a}_{13} {a}_{24} {a}_{32} - {a}_{14} {a}_{22} {a}_{33} + {a}_{14} {a}_{23} {a}_{32} + {a}_{13} {a}_{22} {a}_{34} + {a}_{12} {a}_{24} {a}_{33} ) \\ {A}_{21}^{- 1} = \frac{1}{\vert A \vert} ( - {a}_{21} {a}_{33} {a}_{44} - {a}_{23} {a}_{34} {a}_{41} - {a}_{24} {a}_{31} {a}_{43} + {a}_{24} {a}_{33} {a}_{41} + {a}_{23} {a}_{31} {a}_{44} + {a}_{21} {a}_{34} {a}_{43} ) \\ {A}_{22}^{- 1} = \frac{1}{\vert A \vert} ( {a}_{11} {a}_{33} {a}_{44} + {a}_{13} {a}_{34} {a}_{41} + {a}_{14} {a}_{31} {a}_{43} - {a}_{14} {a}_{33} {a}_{41} - {a}_{13} {a}_{31} {a}_{44} - {a}_{11} {a}_{34} {a}_{43} ) \\ {A}_{23}^{- 1} = \frac{1}{\vert A \vert} ( - {a}_{11} {a}_{23} {a}_{44} - {a}_{13} {a}_{24} {a}_{41} - {a}_{14} {a}_{21} {a}_{43} + {a}_{14} {a}_{23} {a}_{41} + {a}_{13} {a}_{21} {a}_{44} + {a}_{11} {a}_{24} {a}_{43} ) \\ {A}_{24}^{- 1} = \frac{1}{\vert A \vert} ( {a}_{11} {a}_{23} {a}_{34} + {a}_{13} {a}_{24} {a}_{31} + {a}_{14} {a}_{21} {a}_{33} - {a}_{14} {a}_{23} {a}_{31} - {a}_{13} {a}_{21} {a}_{34} + {a}_{11} {a}_{24} {a}_{33} ) \\ {A}_{31}^{- 1} = \frac{1}{\vert A \vert} ( {a}_{21} {a}_{32} {a}_{44} + {a}_{22} {a}_{34} {a}_{41} + {a}_{24} {a}_{31} {a}_{42} - {a}_{24} {a}_{32} {a}_{41} - {a}_{22} {a}_{31} {a}_{44} - {a}_{21} {a}_{34} {a}_{42} ) \\ {A}_{32}^{- 1} = \frac{1}{\vert A \vert} ( - {a}_{11} {a}_{32} {a}_{44} - {a}_{12} {a}_{34} {a}_{41} - {a}_{14} {a}_{31} {a}_{42} + {a}_{14} {a}_{32} {a}_{41} + {a}_{12} {a}_{31} {a}_{44} + {a}_{11} {a}_{34} {a}_{42} ) \\ {A}_{33}^{- 1} = \frac{1}{\vert A \vert} ( {a}_{11} {a}_{22} {a}_{44} + {a}_{12} {a}_{24} {a}_{41} + {a}_{14} {a}_{21} {a}_{42} - {a}_{14} {a}_{22} {a}_{41} - {a}_{12} {a}_{21} {a}_{44} - {a}_{11} {a}_{24} {a}_{42} ) \\ {A}_{34}^{- 1} = \frac{1}{\vert A \vert} ( - {a}_{11} {a}_{22} {a}_{34} - {a}_{12} {a}_{24} {a}_{31} - {a}_{14} {a}_{21} {a}_{32} + {a}_{14} {a}_{22} {a}_{31} + {a}_{12} {a}_{21} {a}_{34} + {a}_{11} {a}_{21} {a}_{32} ) \\ {A}_{41}^{- 1} = \frac{1}{\vert A \vert} ( - {a}_{21} {a}_{32} {a}_{43} - {a}_{22} {a}_{33} {a}_{41} - {a}_{23} {a}_{31} {a}_{42} + {a}_{23} {a}_{32} {a}_{41} + {a}_{22} {a}_{31} {a}_{43} + {a}_{21} {a}_{33} {a}_{42} ) \\ {A}_{42}^{- 1} = \frac{1}{\vert A \vert} ( {a}_{11} {a}_{32} {a}_{43} + {a}_{12} {a}_{33} {a}_{41} + {a}_{13} {a}_{31} {a}_{42} - {a}_{13} {a}_{32} {a}_{41} - {a}_{12} {a}_{31} {a}_{43} - {a}_{11} {a}_{33} {a}_{42} ) \\ {A}_{43}^{- 1} = \frac{1}{\vert A \vert} ( - {a}_{11} {a}_{22} {a}_{43} - {a}_{12} {a}_{24} {a}_{41} - {a}_{13} {a}_{21} {a}_{42} + {a}_{13} {a}_{22} {a}_{41} + {a}_{12} {a}_{21} {a}_{43} + {a}_{11} {a}_{23} {a}_{42} ) \\ {A}_{44}^{- 1} = \frac{1}{\vert A \vert} ( {a}_{11} {a}_{22} {a}_{33} + {a}_{12} {a}_{23} {a}_{31} + {a}_{13} {a}_{21} {a}_{32} - {a}_{13} {a}_{22} {a}_{31} - {a}_{12} {a}_{21} {a}_{33} - {a}_{11} {a}_{23} {a}_{32} ) & [ eq . 5 ]\end{matrix}$$

FIG. 6 is a diagram showing a n equivalent circuit of the coupled circuit 110 constituted by the coils 11, 12, 21 and 22. The excitation reactances and leakage reactances between coils are represented by the following symbols.

excitation reactance of transmission coil 11: Xₜ₁

excitation reactance of transmission coil 12: Xₜ₂

excitation reactance of reception coil 21: Xᵣ₁

excitation reactance of reception coil 22: Xᵣ₂

leakage reactance between transmission coil 11 and transmission coil 12: Xₜ₁ₜ₂

leakage reactance between transmission coil 11 and reception coil 21: Xₜ₁ᵣ₁

leakage reactance between transmission coil 11 and reception coil 22: Xₜ₁ᵣ₂

leakage reactance between transmission coil 12 and reception coil 21: Xₜ₂ᵣ₁

leakage reactance between transmission coil 12 and reception coil 22: Xₜ₂ᵣ₂

leakage reactance between reception coil 21 and reception coil 22: Xᵣ₁ᵣ₂

From the Y matrix indicated in eq. 3, each element constant of the n equivalent circuit of the coupled circuit 110 can be calculated as shown in eq. 6.

$$\begin{matrix}{X}_{t 1 t 2} = - \frac{1}{{Y}_{t 1 t 2}} & {X}_{t 1 r 1} = - \frac{1}{{Y}_{t 1 r 1}} & {X}_{t 1 r 2} = - \frac{1}{{Y}_{t 1 r 2}} \\ {X}_{t 2 r 2} = - \frac{1}{{Y}_{t 2 r 2}} & {X}_{t 1 t2} = - \frac{1}{{Y}_{r 1 t 2}} & {X}_{r 1 r 2} = - \frac{1}{{Y}_{r 1 r 2}}\end{matrix} \\ \begin{matrix}{X}_{t 1} = - \frac{1}{( {Y}_{t 1 t 1} + {Y}_{t 2 t 1} + {Y}_{r 1 t 1} + {Y}_{r 2 t 1} )} \\ {X}_{t 2} = - \frac{1}{( {Y}_{t 1 t 2} + {Y}_{t 2 t 2} + {Y}_{r 1 t 2} + {Y}_{r 2 t 2} )}\end{matrix} \\ \begin{matrix}{X}_{r 1} = - \frac{1}{( {Y}_{t 1 r 1} + {Y}_{t 2 r 1} + {Y}_{r 1 r 1} + {Y}_{r 2 r 1} )} \\ {X}_{r 2} = - \frac{1}{( {Y}_{t 1 r 2} + {Y}_{t 2 r 2} + {Y}_{r 1 r 2} + {Y}_{r 2 r 2} )}\end{matrix} \qquad [ eq . 6 ]$$

Note that eq. 7 below holds true because of duality.

Xₜ₁ₜ₂=Xₜ₂ₜ₁,Xₜ₁ᵣ₁=Xᵣ₁ₜ₁,Xₜ₁ᵣ₂=Xᵣ₂ₜ₁,Xₜ₂ᵣ₁=Xᵣ₁ₜ₂,Xₜ₂ᵣ₂=Xᵣ₂ₜ₂,Xᵣ₁ᵣ₂=Xᵣ₂ᵣ₁ [eq. 7]

FIG. 7 is a diagram showing an exemplary arrangement of the plurality of compensation elements in the compensation circuit 28. As shown in the figure, the plurality of compensation elements in the compensation circuit 28 may be disposed in a mirroring, i.e., axisymmetric, relationship with the coupled circuit 110 as expressed in a n equivalent circuit. For example, in order to counteract the leakage reactance Xₜ₁ᵣ₁ between the transmission coil 11 and the reception coil 21, a compensation element having a reactance −Xₜ₁ᵣ₁ may be connected in series to the reception coil 21. As for the other compensation elements, too, their placement and reactance values may be determined based on similar principles. In the example of FIG. 7, a plurality of compensation elements are disposed which respectively have reactances −Xₜ₁ₜ₂, −Xₜ₁ᵣ₁, −Xₜ₁ᵣ₂, −Xₜ₂ᵣ₁ and −Xᵣ₁ᵣ₂ to counteract the reactances Xₜ₁ₜ₂, Xₜ₁ᵣ₁, Xₜ₁ᵣ₂, Xₜ₂ᵣ₁ and Xᵣ₁ᵣ₂. Such a configuration brings the load impedance as viewed from the power source closer to zero. As a result, interference between the subsystems can be suppressed, and variation in the output voltages due to load variation can be suppressed. Note that the compensation circuit 28 does not need to include all of the compensation elements shown in FIG. 7. Depending on the required power transmission characteristics, some of the compensation elements may be omitted.

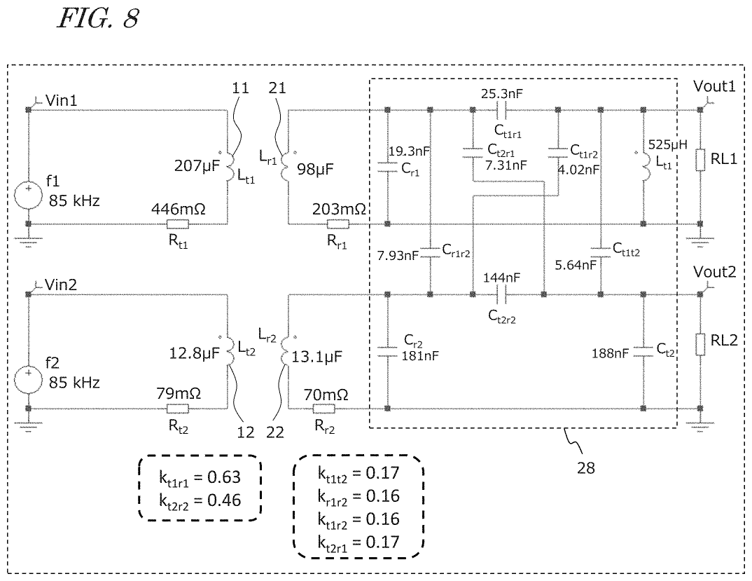

FIG. 8 is a diagram showing an example of a specific configuration of the coupled circuit and the compensation circuit 28 according to the present embodiment. In this example, as compensation elements, the compensation circuit 28 includes an inductor Lₜ₁ and capacitors Cₜ₂, Cᵣ₁, Cᵣ₂, Cₜ₁ᵣ₁, Cₜ₁ₜ₂, Cₜ₁ᵣ₂, Cₜ₂ᵣ₁, Cₜ₂ᵣ₂ and Cᵣ₁ᵣ₂. The inductor Lₜ₁ and the capacitors Cₜ₂, Cᵣ₁, Cᵣ₂, Cₜ₁ᵣ₁, Cₜ₁ₜ₂, Cₜ₁ᵣ₂, Cₜ₂ᵣ₁, Cₜ₂ᵣ₂ and Cᵣ₁ᵣ₂ have their capacitance value or inductance value set so as to possess reactance values respectively corresponding to the reactances −Xₜ₁, −Xₜ₂, −Xᵣ₁, −Xᵣ₂, −Xₜ₁ᵣ₁, −Xₜ₁ₜ₂, −Xₜ₁ᵣ₂, −Xₜ₂ᵣ₁, −Xₜ₂ᵣ₂ and −Xᵣ₁ᵣ₂ shown in FIG. 7.

The inventors have studied the effects of the present embodiment by performing a circuit analysis for the configuration of FIG. 8. In this analysis, the coupling coefficients between coils, the self-inductance of each coil, the capacitance of each capacitor, resistance values, and the power transmission frequencies were set as shown in FIG. 8.

Table 7 shows change in Vout1 and Vout2 in the case where the input voltages are set to Vin1=282 V, Vin2=24 V, with the values of RL1 and RL2 being varied. Herein, rated voltages for the output voltages Vout1 and Vout2 are 282 V and 24 V, respectively.

TABLE 7

| | | | Rate of | | Rate of |
|---|---|---|---|---|---|
| | | | Variation | | Variation |
| RL1 | RL2 | Vout1 | (Vout1- | Vout2 | (Vout2-24)/ |
| [Ω] | [Ω] | [V] | 282)/282 | [V] | 24 |
| 8000 | 140 | 281.9 | 0.0% | 22.3 | −7.1% |
| 110 | 140 | 277.5 | −1.6% | 23.0 | −4.2% |
| 35 | 140 | 268.5 | −4.8% | 24.6 | 2.5% |
| 8000 | 20 | 282.1 | 0.0% | 21.9 | −8.8% |
| 110 | 20 | 277.7 | −1.5% | 22.6 | −5.8% |
| 35 | 20 | 268.6 | −4.8% | 24.2 | 0.8% |
| 8000 | 7 | 282.5 | 0.2% | 21.1 | −12.1% |
| 110 | 7 | 278.0 | −1.4% | 21.7 | −9.6% |
| 35 | 7 | 268.9 | −4.6% | 23.2 | −3.3% |

Table 8 shows change in Vout1 and Vout2 in the case where the input voltages are set to Vin1=0 V, Vin2=24 V.

TABLE 8

| | | | Rate of | | Rate of |
|---|---|---|---|---|---|
| | | | Variation | | Variation |
| RL1 | RL2 | Vout1 | Vout1/ | Vout2 | (Vout2- |
| [Ω] | [Ω] | [V] | 282 | [V] | 24)/24 |
| 8000 | 140 | 2.7 | 1.0% | 23.2 | −3.3% |
| 8000 | 20 | 2.7 | 1.0% | 22.8 | −5.0% |
| 8000 | 7 | 3.2 | 1.1% | 22.0 | −8.3% |

Table 9 shows change in Vout1 and Vout2 in the case where the input voltages are set to Vin1=282 V, Vin2=0 V.

TABLE 9

| | | | Rate of | | Rate of |
|---|---|---|---|---|---|
| | | | Variation | | Variation |
| RL1 | RL2 | Vout1 | (Vout1- | Vout2 | Vout2/ |
| [Ω] | [Ω] | [V] | 282)/282 | [V] | 24 |
| 8000 | 140 | 284.3 | 0.8% | 3.2 | 13.3% |
| 110 | 140 | 279.9 | −0.7% | 2.6 | 10.8% |
| 35 | 140 | 270.8 | −4.0% | 5.2 | 21.7% |

It can be seen from Table 7 to Table 9 that, as compared to the results shown in Table 4 to Table 6, the variation in the output voltage relative to load variation in each subsystem, and the interference between the subsystems, are greatly reduced. It can be seen that the configuration according to the present embodiment provides the effects of stabilization of output voltages and suppression of interference.

Next, some variants of the present embodiment will be described.

### Variant 1 of Embodiment 1

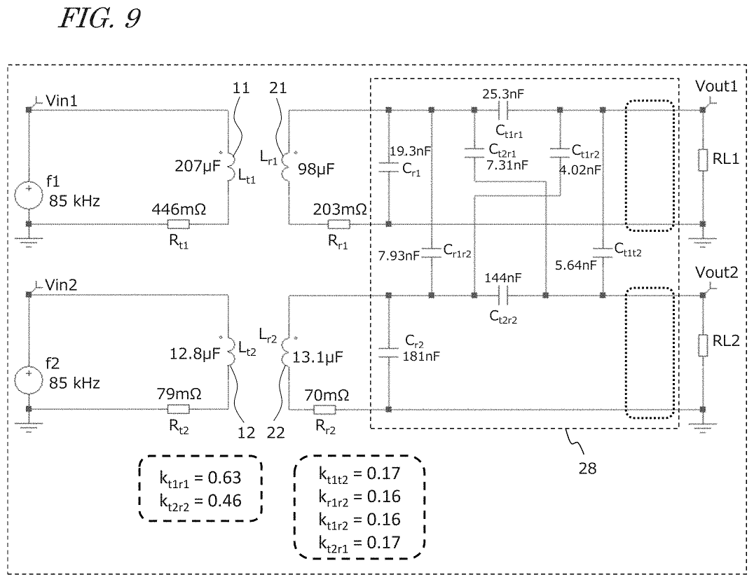

FIG. 9 is a diagram showing a first variant of the present embodiment. In this variant, as indicated by dotted boxes in FIG. 9, the inductor Lₜ₁ and the capacitor Cₜ₂ are eliminated from the configuration shown in FIG. 8. Otherwise, this configuration is identical to what is shown in FIG. 8.

Table 10 shows change in Vout1 and Vout2 in the case where the input voltages are set to Vin1=282 V, Vin2=24 V, with the values of RL1 and RL2 being varied.

TABLE 10

| | | | Rate of | | Rate of |
|---|---|---|---|---|---|
| | | | Variation | | Variation |
| RL1 | RL2 | Vout1 | (Vout1- | Vout2 | (Vout2-24)/ |
| [Ω] | [Ω] | [V] | 282)/282 | [V] | 24 |
| 8000 | 140 | 283.4 | 0.5% | 23.0 | −4.2% |
| 110 | 140 | 279.1 | −1.0% | 23.7 | −1.3% |
| 35 | 140 | 274.6 | −2.6% | 25.5 | 6.3% |
| 8000 | 20 | 283.6 | 0.6% | 22.5 | −6.3% |
| 110 | 20 | 279.3 | −1.0% | 23.2 | −3.3% |
| 35 | 20 | 270.2 | −4.2% | 25.0 | 4.2% |
| 8000 | 7 | 283.9 | 0.7% | 21.6 | −10.0% |
| 110 | 7 | 279.5 | −0.9% | 22.3 | −7.1% |
| 35 | 7 | 270.4 | −4.1% | 23.9 | −0.4% |

Table 11 shows change in Vout1 and Vout2 in the case where the input voltages are set to Vin1=0 V, Vin2=24 V.

TABLE 11

| | | | Rate of | | Rate of |
|---|---|---|---|---|---|
| | | | Variation | | Variation |
| RL1 | RL2 | Vout1 | Vout1/ | Vout2 | (Vout2-24)/ |
| [Ω] | [Ω] | [V] | 282 | [V] | 24 |
| 8000 | 140 | 1.3 | 0.5% | 24.5 | 2.1% |
| 8000 | 20 | 1.5 | 0.5% | 24.0 | 0.0% |
| 8000 | 7 | 2.4 | 0.9% | 23.0 | −4.2% |

Table 12 shows change in Vout1 and Vout2 in the case where the input voltages are set to Vin1=282 V, Vin2=0 V.

TABLE 12

| | | | Rate of | | Rate of |
|---|---|---|---|---|---|
| | | | Variation | | Variation |
| RL1 | RL2 | Vout1 | (Vout1- | Vout2 | Vout2/ |
| [Ω] | [Ω] | [V] | 282)/282 | [V] | 24 |
| 8000 | 140 | 284.6 | 0.9% | 2.2 | 9.2% |
| 110 | 140 | 280.3 | −0.6% | 3.1 | 12.9% |
| 35 | 140 | 271.2 | −3.8% | 5.7 | 23.8% |

It can be seen from Table 10 to Table 12 that, even if the circuitry is simplified by eliminating the compensation elements indicated by dotted boxes in FIG. 9, essentially identical effects to the effects provided by the configuration shown in FIG. 8 are obtained.

### Variant 2 of Embodiment 1

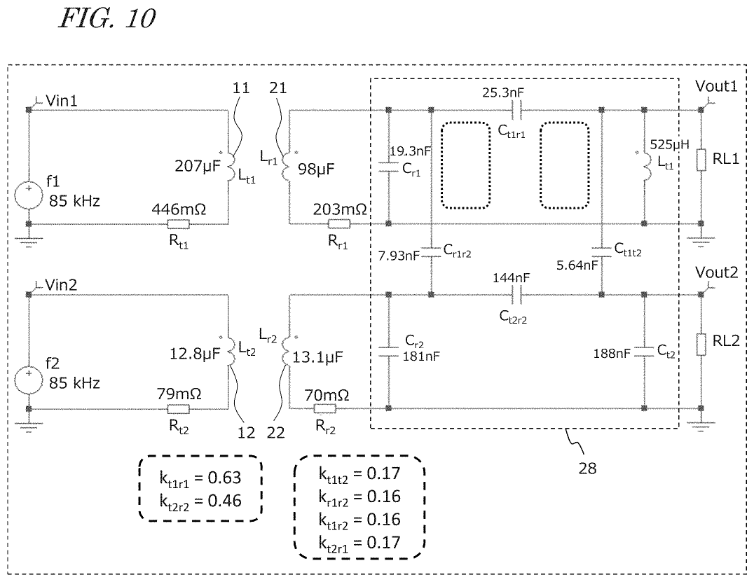

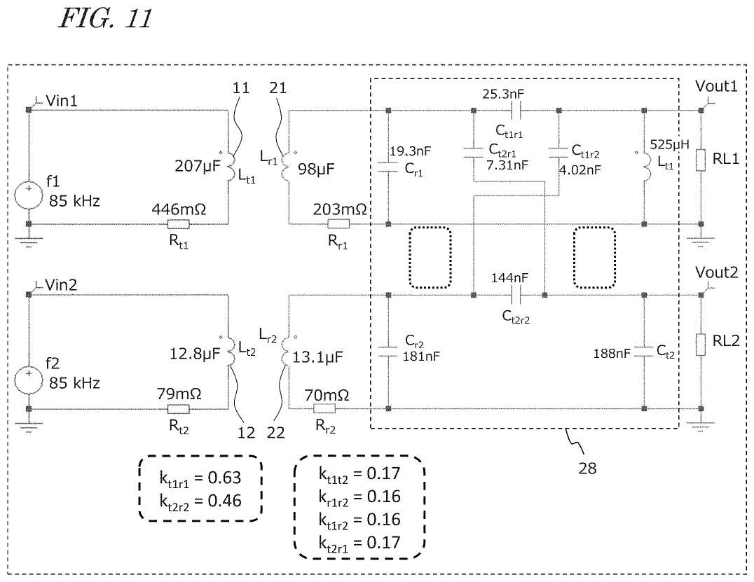

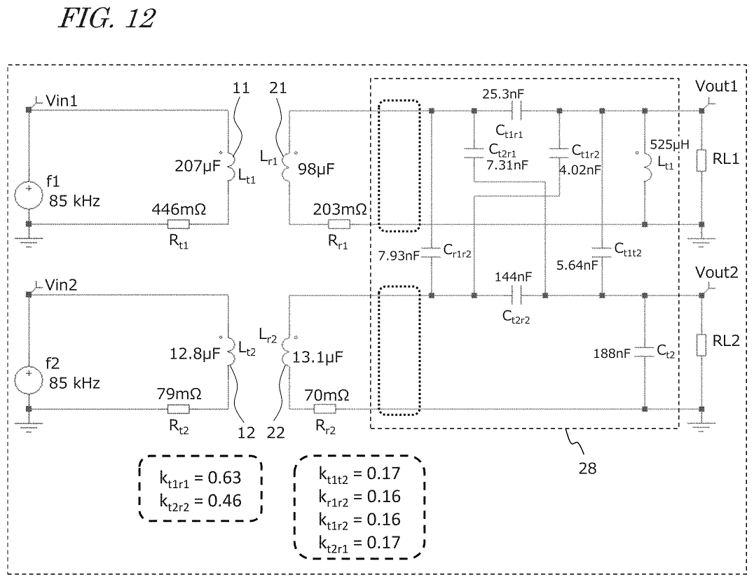

FIG. 10 is a diagram showing a second variant of the present embodiment. In this variant, from the configuration shown in FIG. 8, the capacitors Cₜ₁ᵣ₂ and Cₜ₂ᵣ₁ are eliminated. Otherwise, this configuration is identical to what is shown in FIG. 8.

Table 13 shows change in Vout1 and Vout2 in the case where the input voltages are set to Vin1=282 V, Vin2=24 V.

TABLE 13

| | | | Rate of | | Rate of |
|---|---|---|---|---|---|
| | | | Variation | | Variation |
| RL1 | RL2 | Vout1 | (Vout1-205)/ | | (Vout2-29)/ |
| [Ω] | [Ω] | [V] | 205 | Vout2 | 29 |
| 8000 | 140 | 214.7 | 4.7% | 30.2 | 4.0% |
| 110 | 140 | 210.9 | 2.9% | 30.1 | 3.8% |
| 35 | 140 | 191.6 | −6.5% | 29.2 | 0.8% |
| 8000 | 20 | 214.7 | 4.7% | 29.6 | 2.1% |
| 110 | 20 | 210.8 | 2.8% | 29.5 | 1.8% |
| 35 | 20 | 191.5 | −6.6% | 28.7 | −1.1% |
| 8000 | 7 | 214.2 | 4.5% | 28.3 | −2.3% |
| 110 | 7 | 210.6 | 2.7% | 28.3 | −2.6% |
| 35 | 7 | 191.3 | −6.7% | 27.4 | −5.4% |

Table 14 shows change in Vout1 and Vout2 in the case where the input voltages are set to Vin1=0 V, Vin2=24 V.

TABLE 14

| | | | Rate of | | Rate of |
|---|---|---|---|---|---|
| | | | Variation | | Variation |
| RL1 | RL2 | Vout1 | Vout1/ | Vout2 | (Vout2-29)/ |
| [Ω] | [Ω] | [V] | 205 | [V] | 29 |
| 8000 | 140 | 5.6 | 2.7% | 23.8 | −18.1% |
| 8000 | 20 | 5.6 | 2.7% | 23.3 | −19.6% |
| 8000 | 7 | 5.8 | 2.8% | 22.3 | −23.1% |

Table 15 shows change in Vout1 and Vout2 in the case where the input voltages are set to Vin1=282 V, Vin2=0 V.

TABLE 15

| | | | Rate of | | Rate of |
|---|---|---|---|---|---|
| | | | Variation | | Variation |
| RL1 | RL2 | Vout1 | (Vout1-205)/ | Vout2 | Vout2/ |
| [Ω] | [Ω] | [V] | 205 | [V] | 29 |
| 8000 | 140 | 209.1 | 2.0% | 6.4 | 22.1% |
| 110 | 140 | 205.4 | 0.2% | 6.4 | 22.2% |
| 35 | 140 | 186.6 | −9.0% | 6.1 | 21.1% |

In this example, it can be seen that the effects of stabilization of output voltages and suppression of interference associated with load variation are maintained, although the absolute values of the output voltages change.

### Variant 3 of Embodiment 1

FIG. 11 is a diagram showing a third variant of the present embodiment. In this variant, from the configuration shown in FIG. 8, the capacitors Cₜ₁ₜ₂ and Cᵣ₁ᵣ₂ are eliminated. Otherwise, this configuration is identical to what is shown in FIG. 8.

Table 16 shows change in Vout1 and Vout2 in the case where the input voltages are set to Vin1=282 V, Vin2=24 V.

TABLE 16

| | | | Rate of | | Rate of |
|---|---|---|---|---|---|
| RL1 | RL2 | Vout1 | Variation | Vout2 | Variation |
| [Ω] | [Ω] | [V] | (Vout1 − 200)/200 | [V] | (Vout2 − 40)/40 |
| 8000 | 140 | 210.8 | 5.4% | 36.7 | −8.3% |
| 110 | 140 | 206.5 | 3.3% | 37.9 | −5.4% |
| 35 | 140 | 184.6 | −7.7% | 45.4 | 13.4% |
| 8000 | 20 | 211.1 | 5.6% | 36.0 | −10.0% |
| 110 | 20 | 206.2 | 3.1% | 37.1 | −7.4% |
| 35 | 20 | 183.5 | −8.2% | 44.2 | 10.5% |
| 8000 | 7 | 213.4 | 6.7% | 34.4 | −14.0% |
| 110 | 7 | 207.2 | 3.6% | 35.2 | −12.1% |
| 35 | 7 | 213.3 | 6.7% | 34.4 | −14.0% |

Table 17 shows change in Vout1 and Vout2 in the case where the input voltages are set to Vin1=0 V, Vin2=24 V.

TABLE 17

| RL1 | RL2 | Vout1 | Rate of Variation | Vout2 | Rate of Variation |
|---|---|---|---|---|---|
| [Ω] | [Ω] | [V] | Vout1/200 | [V] | (Vout2 − 40)/40 |
| 8000 | 140 | 6.0 | 3.0% | 23.1 | −42.2% |
| 8000 | 20 | 6.9 | 3.5% | 22.7 | −43.3% |
| 8000 | 7 | 11.4 | 5.7% | 21.7 | −45.8% |

Table 18 shows change in Vout1 and Vout2 in the case where the input voltages are set to Vin1=282 V, Vin2=0 V.

TABLE 18

| RL1 | RL2 | Vout1 | Rate of Variation | Vout2 | Rate of Variation |
|---|---|---|---|---|---|
| [Ω] | [Ω] | [V] | (Vout1 − 200)/200 | [V] | Vout2/40 |
| 8000 | 140 | 204.8 | 2.4% | 13.6 | 33.9% |
| 110 | 140 | 200.7 | 0.3% | 15.2 | 38.1% |
| 35 | 140 | 179.4 | −10.3% | 23.9 | 59.9% |

In this example, too, the effects of stabilization of output voltages and suppression of interference associated with load variation are maintained, although the absolute values of the output voltages change.

### Variant 4 of Embodiment 1

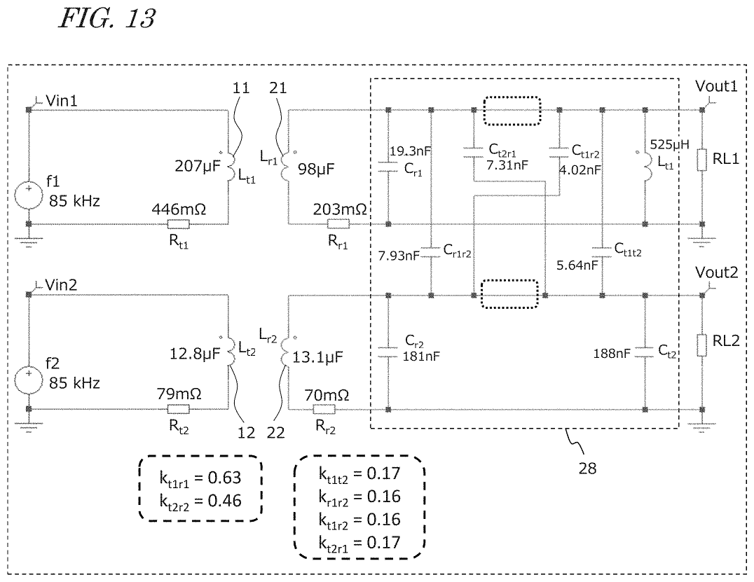

FIG. 12 is a diagram showing a fourth variant of the present embodiment. In this variant, from the configuration shown in FIG. 8, the capacitors Cᵣ₁ and Cᵣ₂ are eliminated. Otherwise, this configuration is identical to what is shown in FIG. 8.

Table 19 shows change in Vout1 and Vout2 in the case where the input voltages are set to Vin1=282 V, Vin2=24 V.

TABLE 19

| RL1 | RL2 | Vout1 | Rate of Variation | Vout2 | Rate of Variation |
|---|---|---|---|---|---|
| [Ω] | [Ω] | [V] | (Vout1 − 125)/125 | [V] | (Vout2 − 17)/17 |
| 8000 | 140 | 140.2 | 12.1% | 19.9 | 17.1% |
| 110 | 140 | 135.6 | 8.4% | 20.1 | 18.1% |
| 35 | 140 | 109.5 | −12.4% | 21.0 | 23.6% |
| 8000 | 20 | 140.4 | 12.3% | 18.8 | 10.4% |
| 110 | 20 | 135.7 | 8.6% | 18.9 | 11.3% |
| 35 | 20 | 109.6 | −12.3% | 19.8 | 16.5% |
| 8000 | 7 | 141.0 | 12.8% | 14.1 | −17.3% |
| 110 | 7 | 136.3 | 9.1% | 14.2 | −16.6% |
| 35 | 7 | 110.1 | −11.9% | 14.8 | −12.7% |

Table 20 shows change in Vout1 and Vout2 in the case where the input voltages are set to Vin1=0 V, Vin2=24 V.

TABLE 20

| RL1 | RL2 | Vout1 | Rate of Variation | Vout2 | Rate of Variation |
|---|---|---|---|---|---|
| [Ω] | [Ω] | [V] | Vout1/125 | [V] | (Vout2 − 17)/17 |
| 8000 | 140 | 3.3 | 2.7% | 10.6 | −37.6% |
| 8000 | 20 | 3.5 | 2.8% | 10.0 | −41.1% |
| 8000 | 7 | 3.8 | 3.0% | 7.5 | −55.9% |

Table 21 shows change in Vout1 and Vout2 in the case where the input voltages are set to Vin1=282 V, Vin2=0 V.

TABLE 21

| RL1 | RL2 | Vout1 | Rate of Variation | Vout2 | Rate of Variation |
|---|---|---|---|---|---|
| [Ω] | [Ω] | [V] | (Vout1 − 125)/125 | [V] | Vout2/17 |
| 8000 | 140 | 136.8 | 9.5% | 9.3 | 54.7% |
| 110 | 140 | 132.3 | 5.9% | 9.5 | 55.7% |
| 35 | 140 | 120.7 | −3.4% | 11.2 | 65.7% |

In this example, too, the effects of stabilization of output voltages and suppression of interference associated with load variation are maintained, although the absolute values of the output voltages change.

### Variant 5 of Embodiment 1

FIG. 13 is a diagram showing a fifth variant of the present embodiment. In this variant, from the configuration shown in FIG. 8, the capacitors Cₜ₁ᵣ₁ and Cₜ₂ᵣ₂ are eliminated. Otherwise, this configuration is identical to what is shown in FIG. 8.

Table 22 shows change in Vout1 and Vout2 in the case where the input voltages are set to Vin1=282 V, Vin2=24 V.

TABLE 22

| RL1 | RL2 | Vout1 | Rate of Variation | Vout2 | Rate of Variation |
|---|---|---|---|---|---|
| [Ω] | [Ω] | [V] | (Vout1 − 125)/125 | [V] | (Vout2 − 17)/17 |
| 8000 | 140 | 503.6 | 78.6% | 31.3 | 30.6% |
| 110 | 140 | 300.2 | 6.5% | 34.2 | 42.7% |
| 35 | 140 | 119.4 | −57.7% | 35.5 | 48.0% |
| 8000 | 20 | 487.5 | 72.9% | 24.0 | 0.1% |
| 110 | 20 | 294.9 | 4.6% | 26.6 | 11.0% |
| 35 | 20 | 121.2 | −57.0% | 28.6 | 19.0% |
| 8000 | 7 | 472.4 | 67.5% | 12.4 | −48.5% |
| 110 | 7 | 300.7 | 6.6% | 14.4 | −39.9% |
| 35 | 7 | 126.3 | −55.2% | 15.8 | −34.2% |

Table 23 shows change in Vout1 and Vout2 in the case where the input voltages are set to Vin1=0 V, Vin2=24 V.

TABLE 23

| RL1 | RL2 | Vout1 | Rate of Variation | Vout2 | Rate of Variation |
|---|---|---|---|---|---|
| [Ω] | [Ω] | [V] | Vout1/125 | [V] | (Vout2 − 17)/17 |
| 8000 | 140 | 22.9 | 8.1% | 29.5 | 23.1% |
| 8000 | 20 | 19.0 | 6.8% | 22.6 | −5.6% |
| 8000 | 7 | 14.0 | 5.0% | 11.7 | −51.5% |

Table 24 shows change in Vout1 and Vout2 in the case where the input voltages are set to Vin1=282 V, Vin2=0 V.

TABLE 24

| RL1 | RL2 | Vout1 | Rate of Variation | Vout2 | Rate of Variation |
|---|---|---|---|---|---|
| [Ω] | [Ω] | [V] | (Vout1 − 125)/125 | [V] | Vout2/17 |
| 8000 | 140 | 526.0 | 86.5% | 60.7 | 252.9% |
| 110 | 140 | 313.6 | 11.2% | 36.9 | 153.6% |
| 35 | 140 | 124.7 | −55.8% | 16.9 | 70.3% |

It can be seen from Table 22 to Table 24 that, in this example, the effects of stabilization of output voltages and suppression of interference associated with load variation are lost. It can be seen from this that, in the circuit configuration of the present embodiment, providing the capacitors Cₜ₁ᵣ₁ and Cₜ₂ᵣ₂ is important in attaining the effects of stabilization of output voltages and suppression of interference.

### Embodiment 2

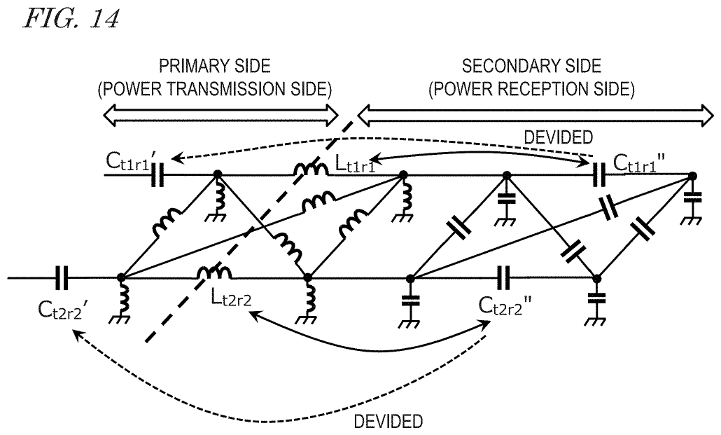

Next, a wireless power supply unit according to illustrative Embodiment 2 of the present disclosure will be described. FIG. 14 is a diagram showing the configuration according to Embodiment 2 of the present disclosure in outline. In the present embodiment, the capacitor Cₜ₁ᵣ₁ for compensating for the leakage reactance (or the leakage inductance Lₜ₁ᵣ₁) between the transmission coil 11 and the reception coil 21 in Embodiment 1 is divided into two capacitors Cₜ₁ᵣ₁′ and Cₜ₁ᵣ₁″. The capacitor Cₜ₁ᵣ₁′ is connected in series to the transmission coil 11. The capacitor Cₜ₁ᵣ₁″ is connected in series to the reception coil 21. The capacitance values of these capacitors are set so as to satisfy 1/Cₜ₁ᵣ₁≈1/Cₜ₁ᵣ₁′+1/Cₜ₁ᵣ₁″. Similarly, the capacitor Cₜ₂ᵣ₂ for compensating for the leakage reactance (or the leakage inductance Lₜ₂ᵣ₂) between the transmission coil 12 and the reception coil 22 is divided into two capacitors Cₜ₂ᵣ₂′ and Cₜ₂ᵣ₂″. The 1 capacitor Cₜ₂ᵣ₂′ is connected in series to the transmission coil 12. The capacitor Cₜ₂ᵣ₂″ is connected in series to the reception coil 22. The capacitance values of these capacitors are set so as to satisfy 1/Cₜ₂ᵣ₂≈1/Cₜ₂ᵣ₂′+1/Cₜ₂ᵣ₂″.

In such a configuration, not only the secondary side, i.e., the power reception, but also the primary side, i.e., the power transmission side, also constitutes a resonant configuration. This enables highly efficient transmission and avoidance of interference between the two subsystems under a large load.

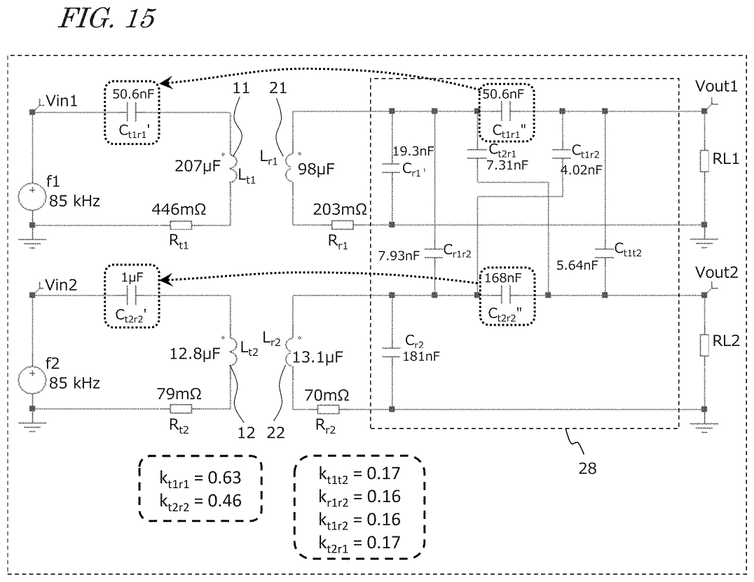

FIG. 15 is a diagram showing an example of a specific configuration of the coupled circuit and the compensation circuit 28 according to the present embodiment. In this example, the compensation circuit 28 includes capacitors Cₜ₁ᵣ₁″ and Cₜ₂ᵣ₂″, instead of the capacitors Cₜ₁ᵣ₁ and Cₜ₂ᵣ₂ in the example shown in FIG. 9. Moreover, capacitors Cₜ₁ᵣ₁′ and Cₜ₂ᵣ₂′ are connected in series to the transmission coils 11 and 12, respectively. The capacitance values of these capacitors are set so as to satisfy 1/Cₜ₁ᵣ₁≈1/Cₜ₁ᵣ₁′+1/Cₜ₁ᵣ₁″ and 1/Cₜ₂ᵣ₂≈1/Cₜ₂ᵣ₂′+1/Cₜ₂ᵣ₂″. Otherwise, this configuration is identical to what is shown in FIG. 9.

Table 25 shows change in Vout1 and Vout2 in the case where the input voltages are set to Vin1=270 V, Vin2=19 V, with the values of RL1 and RL2 being varied.

TABLE 25

| RL1 | RL2 | Vout1 | Rate of Variation | Vout2 | Rate of Variation |
|---|---|---|---|---|---|
| [Ω] | [Ω] | [V] | (Vout1 − 282)/282 | [V] | (Vout2 − 24)/24 |
| 8000 | 140 | 293.8 | 4.2% | 24.5 | 2.1% |
| 110 | 140 | 290.9 | 3.2% | 25.2 | 5.0% |
| 35 | 140 | 284.4 | 0.9% | 27.2 | 13.3% |
| 8000 | 20 | 293.8 | 4.2% | 24.1 | 0.4% |
| 110 | 20 | 290.8 | 3.1% | 24.7 | 2.9% |
| 35 | 20 | 284.1 | 0.7% | 26.7 | 11.3% |
| 8000 | 7 | 293.6 | 4.1% | 23.0 | −4.2% |
| 110 | 7 | 290.3 | 2.9% | 23.6 | −1.7% |
| 35 | 7 | 283.1 | 0.4% | 25.4 | 5.8% |

Table 26 shows change in Vout1 and Vout2 in the case where the input voltages are set to Vin1=0 V, Vin2=19 V.

TABLE 26

| RL1 | RL2 | Vout1 | Rate of Variation | Vout2 | Rate of Variation |
|---|---|---|---|---|---|
| [Ω] | [Ω] | [V] | Vout1/282 | [V] | (Vout2 − 24)/24 |
| 8000 | 140 | 6.8 | 2.4% | 30.5 | 27.1% |
| 8000 | 20 | 6.9 | 2.4% | 29.9 | 24.6% |
| 8000 | 7 | 8.3 | 2.9% | 28.6 | 19.2% |

Table 27 shows change in Vout1 and Vout2 in the case where the input voltages are set to Vin1=270 V, Vin2=0 V.

TABLE 27

| RL1 | RL2 | Vout1 | Rate of Variation | Vout2 | Rate of Variation |
|---|---|---|---|---|---|
| [Ω] | [Ω] | [V] | (Vout1 − 282)/282 | [V] | Vout2/24 |
| 8000 | 140 | 300.6 | 6.6% | 6.2 | 25.8% |
| 110 | 140 | 297.6 | 5.5% | 7.1 | 29.6% |
| 35 | 140 | 291.0 | 3.2% | 11.6 | 48.3% |

It can be seen from these results that dividing the capacitance so as to dispose a capacitor also on the power transmission side allows for an enhanced stability of output voltages especially under a high load state.

The inventors have found that, by dividing the capacitance as in the present embodiment so as to dispose a capacitor also on the power transmission side, transient variation in output voltages associated with load variation can be suppressed. Hereinafter, this effect will be described.

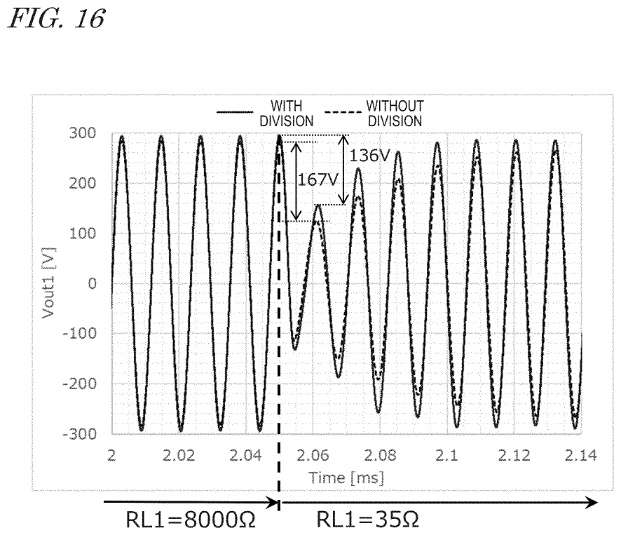

FIG. 16 is a graph showing results of analysis of transient variation in the output voltage Vout1 under a varying load RL1. In this example, a voltage variation immediately after switching the load RL1 from 8000Ω to 35Ω was analyzed. The analysis was performed with respect to both the circuit configuration of Embodiment 1, where the capacitance was not divided, and the circuit configuration of the present embodiment, where the capacitance was divided.

The amount of drop in the voltage Vout1 immediately after load switching was as follows.

with capacitance division: 136 V (−59%)

without capacitance division: 167 V (−48%)

Thus, by adopting a configuration where the capacitance is divided, a drop in the output voltage associated with load variation can be suppressed. In other words, with the configuration of the present embodiment, transient variation in output voltages associated with load variation can be suppressed.

### Variant of Embodiment 2

Next, a variant of the present embodiment will be described.

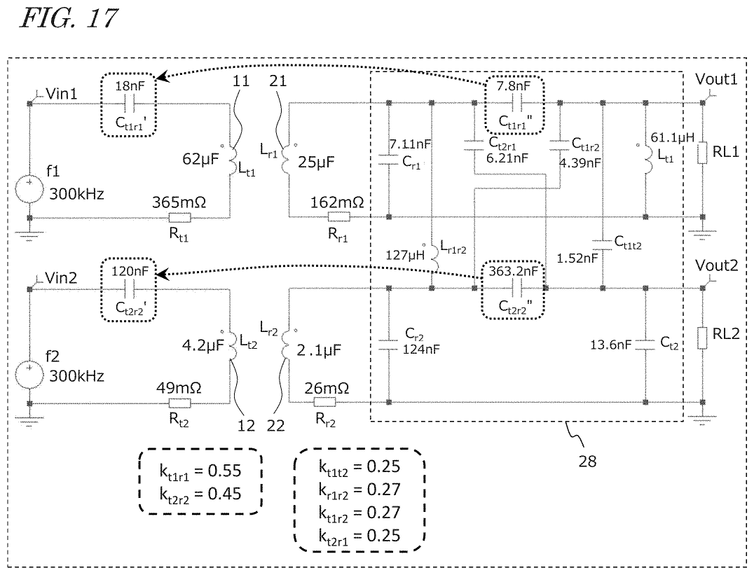

FIG. 17 is a diagram showing a variant of the present embodiment. In this variant, the power transmission frequencies and the parameters of each circuit element are different from those in the above-described examples. In this example, as compared to the above-described examples, coupling within each subsystem is weak, while coupling between the subsystems is strong. Moreover, the power transmission frequencies f1 and f2 are both as high as 300 kHz. The parameters of each circuit element are as shown in FIG. 17.

Table 28 shows change in Vout1 and Vout2 in the case where the input voltages are set to Vin1=400 V, Vin2=12 V, with the values of RL1 and RL2 being varied.

TABLE 28

| RL1 | RL2 | Vout1 | Rate of Variation | Vout2 | Rate of Variation |
|---|---|---|---|---|---|
| [Ω] | [Ω] | [V] | (Vout1 − 400)/400 | [V] | (Vout2 − 19)/19 |
| 8000 | 140 | 412.7 | 3.2% | 19.7 | −1.5% |
| 110 | 140 | 412.1 | 3.0% | 19.7 | −1.6% |
| 35 | 140 | 406.9 | 1.7% | 20.7 | 3.5% |
| 8000 | 20 | 412.6 | 3.1% | 19.6 | −1.9% |
| 110 | 20 | 412.0 | 3.0% | 19.6 | −2.0% |
| 35 | 20 | 406.7 | 1.7% | 20.6 | 3.0% |
| 8000 | 7 | 411.3 | 2.8% | 18.1 | −9.5% |
| 110 | 7 | 410.7 | 2.7% | 18.1 | −9.6% |
| 35 | 7 | 404.7 | 1.2% | 19.0 | −5.1% |

Table 29 shows change in Vout1 and Vout2 in the case where the input voltages are set to Vin1=0 V, Vin2=12 V.

TABLE 29

| RL1 | RL2 | Vout1 | Rate of Variation | Vout2 | Rate of Variation |
|---|---|---|---|---|---|
| [Ω] | [Ω] | [V] | Vout1/400 | [V] | (Vout2 − 19)/19 |
| 8000 | 140 | 3.9 | 1.0% | 20.6 | 3.0% |
| 8000 | 20 | 4.1 | 1.0% | 20.5 | 2.6% |
| 8000 | 7 | 6.2 | 1.5% | 18.9 | −5.4% |

Table 30 shows change in Vout1 and Vout2 in the case where the input voltages are set to Vin1=400 V, Vin2=0 V.

TABLE 30

| RL1 | RL2 | Vout1 | Rate of Variation | Vout2 | Rate of Variation |
|---|---|---|---|---|---|
| [Ω] | [Ω] | [V] | (Vout1 − 400)/400 | [V] | Vout2/19 |
| 8000 | 140 | 408.8 | 2.2% | 40.3 | 201.5% |
| 110 | 140 | 408.1 | 2.0% | 40.2 | 201.2% |
| 35 | 140 | 397.1 | −0.7% | 42.3 | 211.3% |

In this example, the absolute value of Vout2 tends to increase; however, as in the above-described examples, the effects of stabilization of output voltages and suppression of interference were confirmed.

In the above-described examples, the input voltages Vin1 and Vin2 are in equiphase relationship, but the phase difference between Vin1 and Vin2 may be changed.

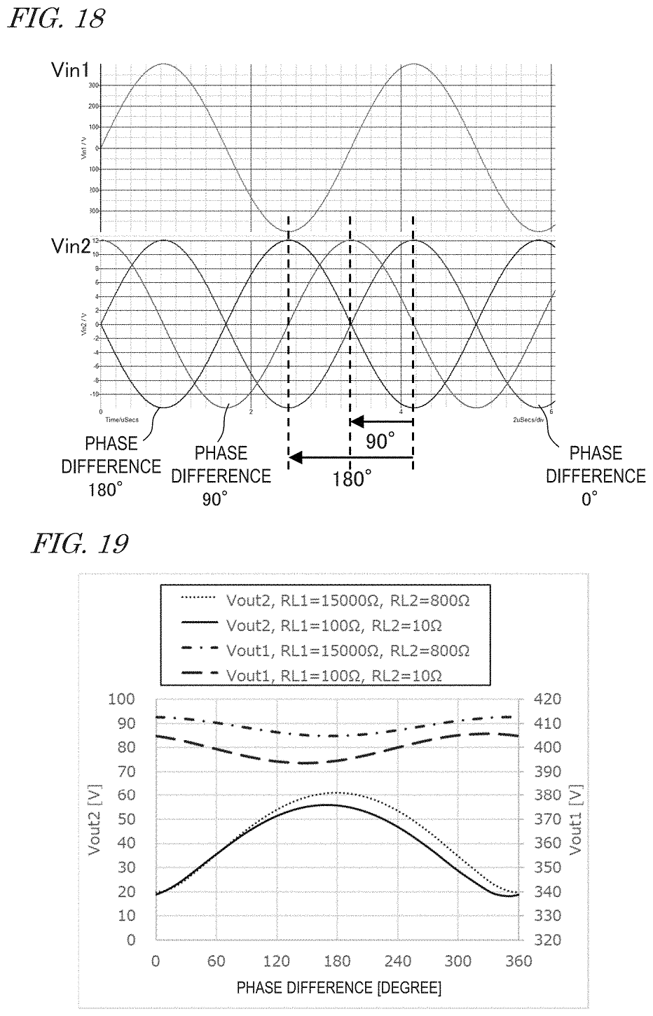

FIG. 18 is a diagram showing example waveforms of Vin1 and Vin2 in the cases where the phase difference between Vin1 and Vin2 is 0°, 90° and 180°. FIG. 19 is a diagram illustrating that changing the phase difference between Vin1 and Vin2 allows Vout1 and Vout2 to be changed. As shown in FIG. 19, by changing the phase difference between the input voltages of the subsystems, the absolute values of the output voltages Vout1 and Vout2 can be altered. Change in the phase difference between the input voltages of the subsystems can be achieved by the control circuit 19 shown in FIG. 3 controlling the ON/OFF timing of the plurality of switching elements included in the inverter circuits 13 and 14. Even when the phase difference is changed, the effects of stabilization of output voltages and suppression of interference are obtained.

### Embodiment 3

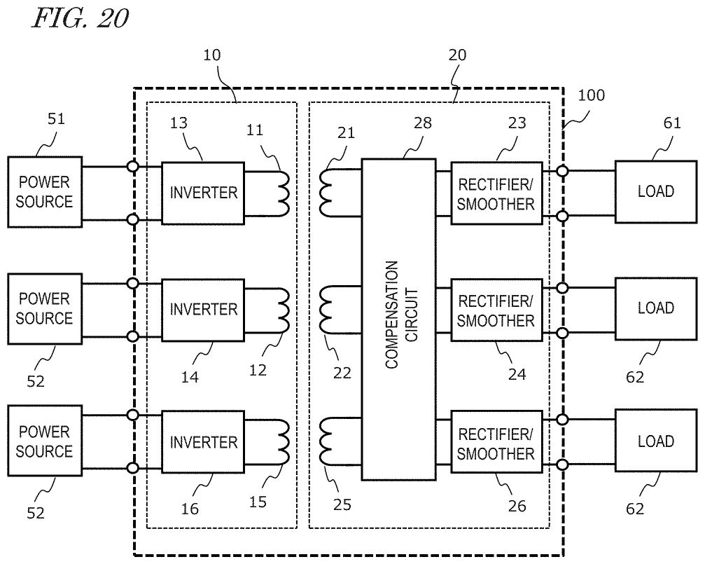

FIG. 20 is a diagram schematically showing the configuration of a wireless power transmission system according to illustrative Embodiment 3 of the present disclosure. In addition to the component elements shown in FIG. 3, the power transmitting module 10 according to the present embodiment further includes a third transmission coil 15 and a third inverter circuit 16. In addition to the component elements shown in FIG. 3, the power receiving module 20 further includes a third reception coil 25 and a third rectifier circuit 26. The compensation circuit 28 is connected also to the third reception coil 25. The control circuit 19 is omitted from illustration in FIG. 20. Otherwise, this configuration is identical to what is shown in FIG. 3.

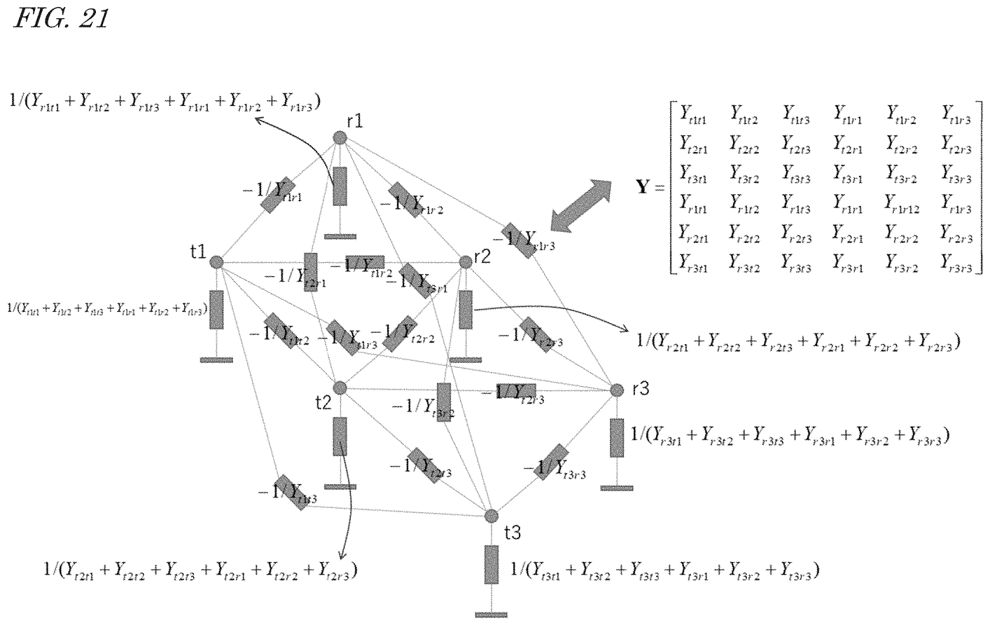

FIG. 21 is a diagram showing a coupled circuit constituted by the transmission coils 11, 12 and 15 and the reception coils 21, 22 and 25 in the present embodiment in a n equivalent circuit. As shown in FIG. 21, leakage reactances and excitation reactances between the coil pairs are expressed by elements of a Y matrix. The plurality of compensation elements in the compensation circuit 28 are disposed so as to counteract these reactances. As a result, as in Embodiments 1 and 2, effects of stabilization of output voltages and suppression of mutual interference between coils can be obtained.

Thus, as in the case of two subsystems, by disposing a compensation element for the respective elements, extension to three subsystems becomes possible. Extension to a configuration featuring four or more subsystems can also be attained by a similar method.

### Application Example

Next, as an application example of a wireless power supply unit according to an embodiment of the present disclosure, an exemplary electrically operated apparatus, such as a robot arm apparatus, will be described.

Electrically operated apparatuses, e.g., robot hand apparatuses, which perform various operations by using an end effector(s) connected to the leading end(s) of one or more arms are being developed. Such electrically operated apparatuses are utilized in various kinds of work, such as carrying articles at a factory.

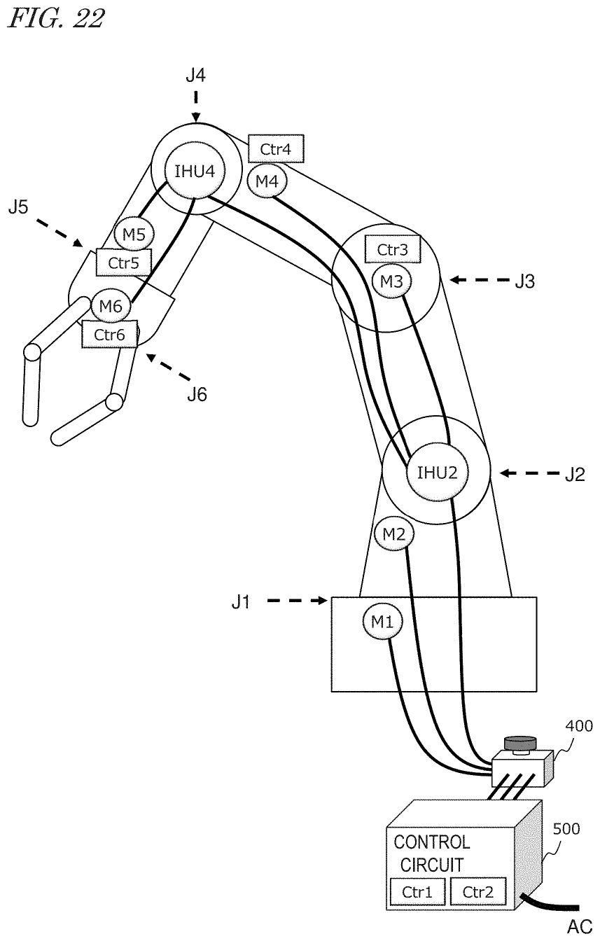

FIG. 22 is a diagram showing an example of a robot arm apparatus in which the above-described wireless power transmission is applied. This robot arm apparatus has joints J1 to J6. Among these, the above-described wireless power transmission is applied to the joints J2 and J4. On the other hand, conventional wired power transmission is applied to the joints J1, J3, J5, and J6. The robot arm apparatus includes: a plurality of motors M1 to M6 which respectively drive the joints J1 to J6; motor control circuits Ctr3 to Ctr6 which respectively control the motors M3 to M6 among the motors M1 to M6; and two wireless power supply units (intelligent robot harness units; also referred to as IHUs) IHU2 and IHU4 which are respectively provided in the joints J2 and J4. Motor control circuits Ctr1 and Ctr2 which respectively drive the motors M1 and M2 are provided in a control device (controller) 500 which is external to the robot.

The controller 500 supplies electric power to the motors M1 and M2 and the wireless power supply unit IHU2 in a wired manner. At the joint J2, the wireless power supply unit IHU2 wirelessly transmits electric power via a pair of coils. The transmitted electric power is then supplied to the motors M3 and M4, the control circuits Ctr3 and Ctr4, and the wireless power supply unit IHU4. The wireless power supply unit IHU4 also wirelessly transmits electric power via a pair of coils in the joint J4. The transmitted electric power is supplied to the motors M5 and M6 and the control circuits Ctr5 and Ctr6. With such a configuration, cables for power transmission can be eliminated in the joints J2 and J4.

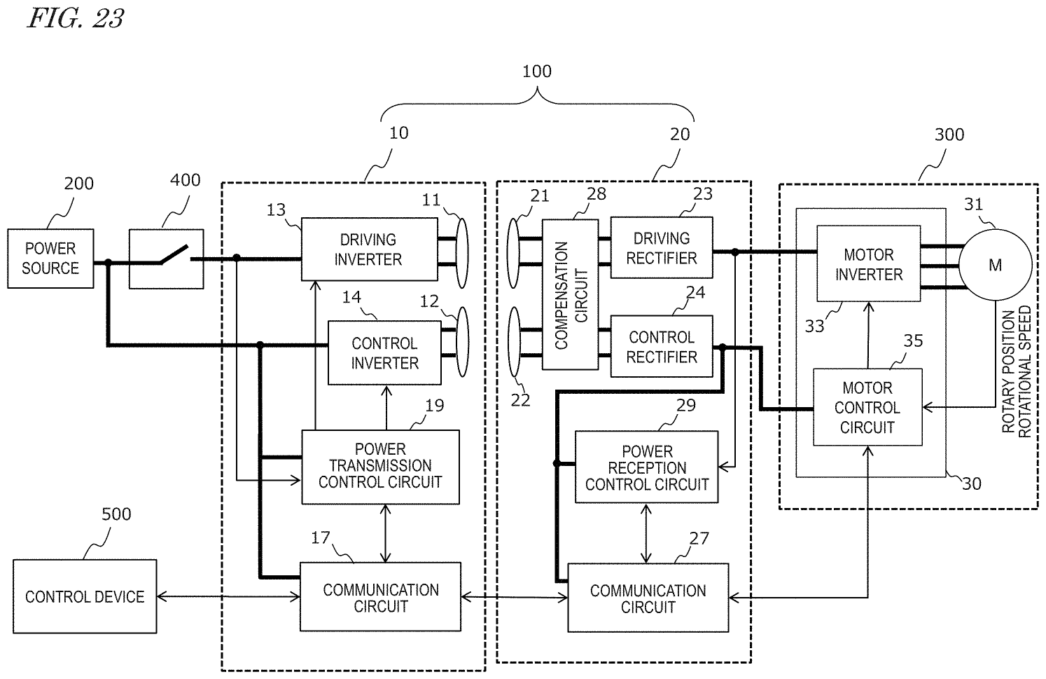

FIG. 23 is a block diagram showing the configuration of the wireless power transmission system in this example. The wireless power transmission system includes a wireless power supply unit 100, a power source 200 which is connected to the wireless power supply unit 100, an emergency stop switch 400, an actuator 300, and a controller 500. In FIG. 23, thick lines indicate supply lines of electric power, whereas arrows indicate supply lines of signals.

The wireless power supply unit 100 includes a power transmitting module 10 and a power receiving module 20. The power transmitting module 10 includes a first inverter circuit (also referred to as a “driving inverter”) 13, a first transmission coil 11, a second inverter circuit (also referred to as a “control inverter”) 14, a second transmission coil 12, a power transmission control circuit 19, and a first communication circuit 17. The driving inverter 13, which is connected to the power source 200 via the switch 400, converts supplied electric power into first AC power and outputs it. The first transmission coil 11, which is connected to the driving inverter 13, sends out the first AC power. The control inverter 14, which is connected to the power source 200 not via the switch 400, converts supplied electric power into second AC power and outputs it. The second transmission coil 12, which is connected to the control inverter 14, sends out the second AC power. The power transmission control circuit 19, which is connected to the power source 200 not via the switch 400, controls the driving inverter 13, the control inverter 14, and the first communication circuit 17. The first communication circuit 17 is connected to the power source 200 not via the switch 400. The first communication circuit 17 sends a signal for controlling the motor 31 (as one example of a load) in the actuator 300. The signal for controlling the motor 31 may be a signal representing a command value of e.g. rotational speed of the motor 31, for example. The signal is supplied from the external controller 500 to the power transmitting module 10.

The power receiving module 20 includes a first reception coil 21, a first rectifier circuit (also referred to as a “driving rectifier”) 23, a second reception coil 22, a second rectifier circuit (also referred to as a “control rectifier”) 24, a compensation circuit 28, a power reception control circuit 29, and a second communication circuit 27. The first reception coil 21 is opposed to the first transmission coil 11. The first reception coil 21 receives at least a portion of the first AC power which is sent out from the first transmission coil 11. The driving rectifier 23, which is connected to the first reception coil 21 via the compensation circuit 28, converts the AC power received by the first reception coil 21 into first DC power and outputs it. The second reception coil 22 is opposed to the second transmission coil 12. The second reception coil 22 receives at least a portion of the second AC power which has been transmitted from the second transmission coil 12. The control rectifier 24, which is connected to the second reception coil 22 via the compensation circuit 28, converts the AC power received by the second reception coil 22 into second DC power and outputs it. The compensation circuit 28 counteracts at least a part of leakage reactances and excitation reactances between the transmission coils 11 and 12 and the reception coils 21 and 22. The power reception control circuit 29 is driven by the second DC voltage output from the control rectifier 24, and controls the second communication circuit 27. The second communication circuit 27 performs communications between the first communication circuit 17 on the power transmission side and the motor control circuit 35 in the actuator 300. The second communication circuit 27 receives a signal which has been sent from the first communication circuit 17, and sends it to the motor control circuit 35. In response to a request from the motor control circuit 35, the second communication circuit 27 may send a signal with which to perform an operation of compensating for the load variation in the motor 31, for example, to the first communication circuit 17. Based on this signal, the power transmission control circuit 19 can control the driving inverter 13 to adjust drive power. As a result, for example, an always-constant voltage may be given to the motor inverter 33 in the actuator 300.

The actuator 300 according to the present embodiment causes the power receiving module 20 to move or rotate relative to the power transmitting module 10. During this operation, the first transmission coil 11 and the first reception coil 21 maintain an opposed state, and the second transmission coil 12 and the second reception coil 22 also maintain an opposed state. The actuator 300 includes a servo motor 31 which is driven by a three-phase current, and a motor amplifier 30 to drive the motor 31. The motor amplifier 30 includes: a motor inverter 33 which converts the DC power having been output from the driving rectifier 23 into three-phase AC power, and supplies it to the motor 31; and a motor control circuit 35 which controls the motor inverter 33. During operation of the motor 31, the motor control circuit 35 detects information on rotary position and rotational speed by using e.g. a rotary encoder, and based on this information, controls the motor inverter 33 so as to realize a desired rotating operation. Note that the motor 31 may not be a motor which is driven with a three-phase current. In the case where the motor 31 is a DC-driven motor, a motor driving circuit which is suited for that motor configuration is to be used instead of a three phase inverter.

At least a portion of the first DC power which is output from the driving rectifier 23 is supplied to the motor inverter 33. At least a portion of the second DC power which is output from the control rectifier 24 is supplied to the motor control circuit 35. Even if the switch 400 is turned OFF during operation of the driving inverter 13 and the control inverter 14 so that supply of power to the driving inverter 13 is stopped, the power transmission control circuit 19 maintains control of the control inverter 14. As a result, even after supply of power to the motor inverter 33 is stopped, supply of power to the motor control circuit 35 is maintained. Since the motor control circuit 35 stores the operation status existing at the time when the motor 31 stops, it is possible to swiftly resume the operation of the actuator 300 when the switch 400 is turned ON again so that powering is begun again.

In order to realize the above operation, the power transmission control circuit 19 performs power transmission control while monitoring the electric power which is supplied to the driving inverter 13. By detecting a decrease in the electric power value that is being input to the driving inverter 13, the power transmission control circuit 19 detects that the emergency stop switch 400 has been pressed (i.e., the switch 400 has been turned OFF). Upon detecting a decrease (or stop) of the supplied electric power, the power transmission control circuit 19 stops control of the driving inverter 13, while maintaining control of the control inverter 14. In the meantime, the power transmission control circuit 19 may instruct the communication circuit 17 to send a predetermined signal (e.g., a command to stop the motor) to the motor control circuit 35. Upon receiving this signal, the motor control circuit 35 can stop controlling the motor inverter 33. When electric power to the driving system is suspended, this prevents unnecessary inverter control from being continued.

Next, the configuration of the respective component elements in the present embodiment will be described in more detail.

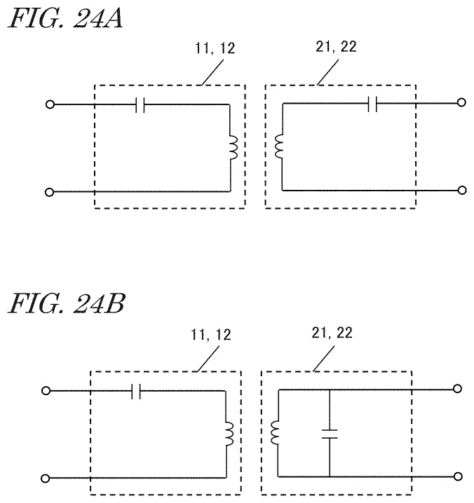

FIG. 24A is a diagram showing an exemplary equivalent circuit of the transmission coil 11, 12 and the reception coil 21, 22 in the wireless power supply unit 100. As shown in the figure, each coil functions as a resonant circuit having an inductance component and a capacitance component. By ensuring that the resonant frequencies of two coils opposing each other have close values, electric power can be transmitted with a high efficiency. The transmission coil receives AC power supplied from the inverter circuit. Owing to a magnetic field that is generated with this AC power from the transmission coil, electric power is transmitted to the reception coil. In this example, the transmission coil 11, 12 and the reception coil 21, 22 both function as series resonant circuits.

FIG. 24B is a diagram showing another exemplary equivalent circuit of the transmission coil 11, 12 and the reception coil 21, 22 in the wireless power supply unit 100. In this example, the transmission coil 11, 12 functions as a series resonant circuit, whereas the reception coil 21, 22 functions as a parallel resonant circuit. In another possible implementation, the transmission coil 11, 12 may constitute a parallel resonant circuit.

Each coil may be a planar coil or a laminated coil that is formed on a circuit board, or a wound coil of a copper wire, a litz wire, a twisted wire, or the like, for example. Each capacitance component in the resonant circuit may be realized by a parasitic capacitance of the coil, or a capacitor having a chip shape or a lead shape may be separately provided, for example.

The resonant frequency f0 of the resonant circuit is typically set to be equal to the transmission frequency f1 during power transmission. It is not necessary for the resonant frequency f0 of each of the resonant circuits to be exactly equal to the transmission frequency f1. The resonant frequency f0 of each may be set to a value in the range of about 50 to about 150% of the transmission frequency f1, for example. The frequency f1 of the power transmission may be e.g. 50 Hz to 300 GHz; 20 kHz to 10 GHz in one example; 20 kHz to 20 MHz in another example; and 80 kHz to 14 MHz in still another example. Within any such frequency band, a frequency of drive power and a frequency of control power may be selected. The frequency of drive power and the frequency of control power may be set to different values.

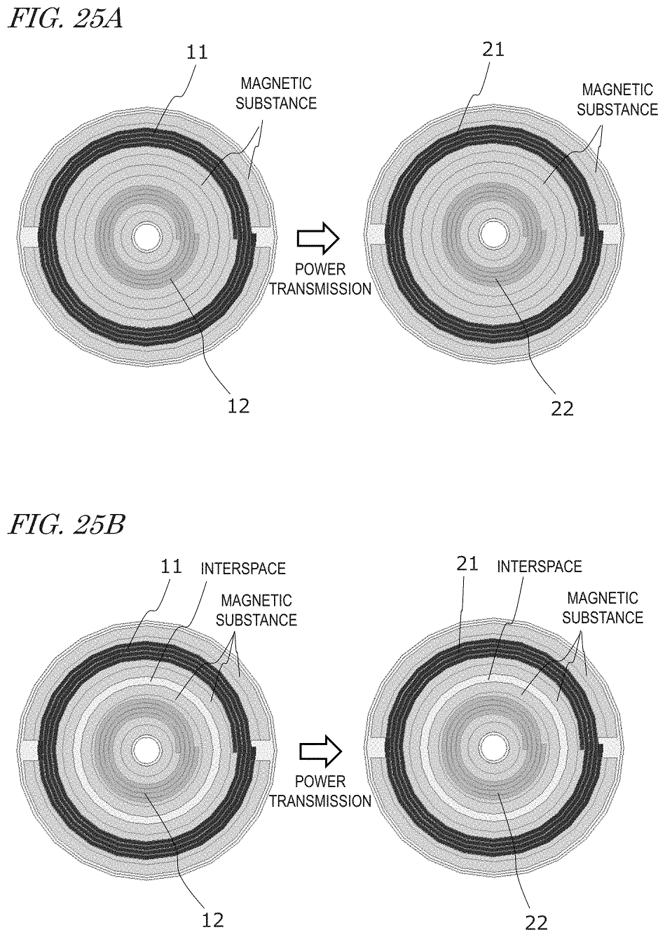

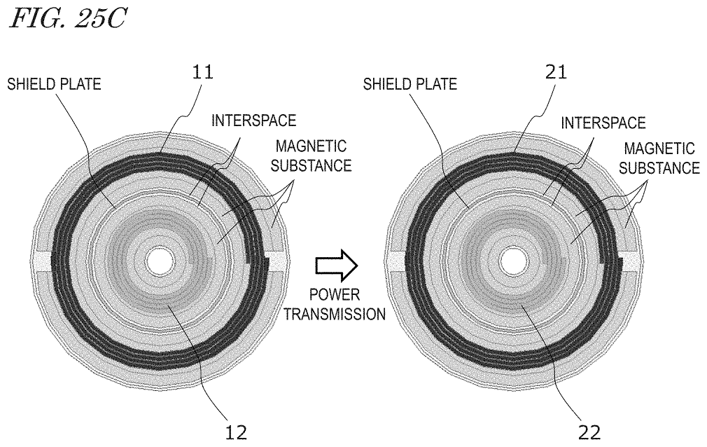

FIG. 25A is a diagram showing exemplary relative positions of the transmission coils 11 and 12 and the reception coils 21 and 22. The structure in this example may be applied to a coil in a movable section that is capable of rotating, such as a joint of a robot. Although the reception coils 21 and 22 actually are opposed respectively to the transmission coils 11 and 12, FIG. 25A illustrates these coils as being side by side, for ease of understanding. In this example, the transmission coils 11 and 12 and the reception coils 21 and 22 are all planar coils of circular shape. The transmission coils 11 and 12 are disposed concentrically, such that the transmission coil 12 fits inside the transmission coil 11. Similarly, the reception coils 21 and 22 are disposed concentrically, such that the reception coil 22 fits inside the reception coil 21. Contrary to this example, the transmission coil 11 may be disposed inside the transmission coil 12, and the reception coil 21 may be disposed inside the reception coil 22. Each of the transmission coils 11 and 12 and the reception coils 21 and 22 in this example is covered with a magnetic substance.

FIG. 25B is a diagram showing another exemplary configuration for the transmission coils 11 and 12 and the reception coils 21 and 22. In the example of FIG. 25B, an interspace (air gap) exists between the magnetic substance covering the transmission coil 11 and the magnetic substance covering the transmission coil 12, and between the magnetic substance covering the reception coil 21 and the magnetic substance covering the reception coil 22. Providing such air gaps suppresses electromagnetic interference between coils.

FIG. 25C is a diagram showing still another exemplary configuration for the transmission coils 11 and 12 and the reception coils 21 and 22. In the example of FIG. 25C, a shield plate is further added to the configuration shown in FIG. 25B. The shield plate shown in the figure is an electrically conductive member of annular shape which is disposed in the interspace between pieces of magnetic substance. Adding a shield plate inside an air gap allows for further suppression of electromagnetic interference between coils.

The shapes and relative positions of the transmission coils 11 and 12 and the reception coils 21 and 22 are not limited to those exemplified in FIGS. 25A to 25C, and they permit various structures. For example, in any site of a robot arm that undergoes linear motion (e.g., expansion or contraction), a coil of rectangular shape may be used.

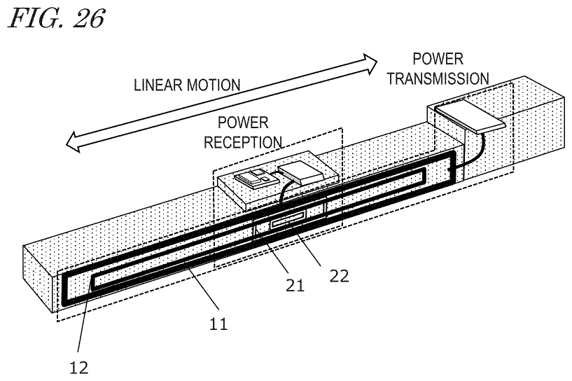

FIG. 26 is a perspective view showing another exemplary arrangement of coils 11, 12, 21 and 22 in a linear motion section of an arm. In this example, each coil 11, 12, 21, 22 has a rectangular shape which is elongated in the direction that the arm moves. The transmission coils 11 and 12 are respectively larger than the reception coils 21 and 22. Moreover, the transmission coil 11 is larger than the transmission coil 12, and the reception coil 21 is larger than the reception coil 22. With this configuration, even if the power receiving module moves relative to the power transmitting module, the coils will remain opposed. In the configuration shown in FIG. 26, the transmission coil 11 may be smaller than the transmission coil 12, and the reception coil 21 may be smaller than the reception coil 22.

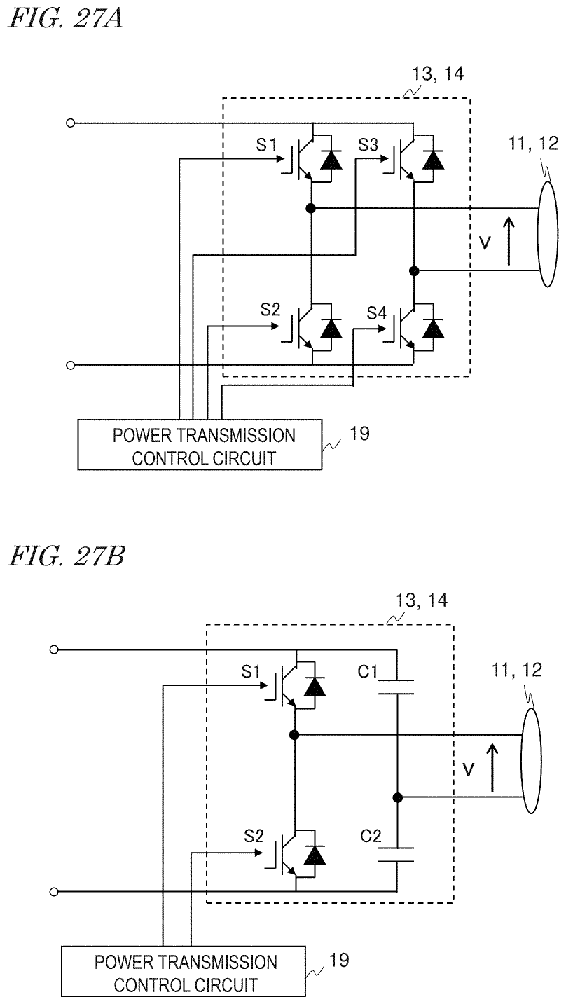

FIGS. 27A and 27B are diagrams showing exemplary configurations for each inverter circuit 13, 14. FIG. 27A shows an exemplary configuration of a full-bridge type inverter circuit. In this example, by controlling ON or OFF of the four switching elements S1 to S4 included in the inverter circuit 13 or 14, the power transmission control circuit 19 converts input DC power into AC power having a desired frequency f and voltage V (effective values). In order to realize this control, the power transmission control circuit 19 may include a gate driver circuit that supplies a control signal to each switching element. FIG. 27B shows an exemplary configuration of a half-bridge type inverter circuit. In this example, by controlling ON or OFF of the two switching elements S1 and S2 included in the inverter circuit 13 or 14, the power transmission control circuit 19 converts input DC power into AC power having a desired frequency f and voltage V (effective values). The inverter circuit 13 or 14 may have a different structure from what is shown in FIG. 27A or 27B.

The power transmission control circuit 19, the power reception control circuit 29, and the motor control circuit 35 can be implemented as circuits including a processor and a memory, e.g., microcontroller units (MCU). By executing a computer program which is stored in the memory, various controls can be performed. The power transmission control circuit 19, the power reception control circuit 29, and the motor control circuit 35 may be implemented in special-purpose hardware that is adapted to perform the operation according to the present embodiment

The communication circuits 17 and 27 are able to transmit or receive signals by using a known wireless communication technique, optical communication technique, or modulation technique (e.g., frequency modulation or load modulation), for example. The mode of communication by the communication circuits 17 and 27 may be arbitrary, without being limited to any particular mode.

The motor 31 may be a motor that is driven with a three-phase current, e.g., a permanent magnet synchronous motor or an induction motor, although this is not a limitation. The motor 31 may any other type of motor, such as a DC motor. In that case, instead of the motor inverter 33 (which is a three-phase inverter circuit), a motor driving circuit which is suited for the structure of the motor 31 is to be used.

The power source 200 may be any power source that outputs DC power. The power source 200 may be any power source, e.g., a mains supply, a primary battery, a secondary battery, a photovoltaic cell, a fuel cell, a USB (Universal Serial Bus) power source, a high-capacitance capacitor (e.g., an electric double layer capacitor), or a voltage converter that is connected to a mains supply, for example.

The switch 400 is a switch for emergency stop, and has the aforementioned direct opening mechanism. However, this is not a limitation; the technique of the present disclosure is applicable also to other types of switches. The switch 400 selectively establishes conduction/non-conduction between the power source 200 and the driving inverter 13.

The controller 500 is a control device which controls the operation each load that is included in the wireless power transmission system. The controller 500 determines load command values (e.g., rotational speed and torque) that determine the operation status of the motor 31 of the actuator 300, and send them to the communication circuit 17.

### INDUSTRIAL APPLICABILITY

The technique according to the present disclosure is applicable to any application in which electric power is wirelessly transmitted. For example, it is usable in electrically operated apparatuses such as robots.

### REFERENCE SIGNS LIST

10 power transmitting module
11 first transmission coil
12 second transmission coil
13 first inverter circuit
14 second inverter circuit
15 third transmission coil
16 third inverter circuit
17 communication circuit
19 control circuit
20 power receiving module
21 first reception coil
22 second reception coil
23 first rectifier circuit
24 second rectifier circuit
25 third reception coil
26 third rectifier circuit
27 communication circuit
28 compensation circuit
29 power reception control circuit
31 motor
33 motor inverter circuit
35 motor control circuit
51 first power source
52 second power source
61 first load
62 second load
100 wireless power supply unit
110 coupled circuit
200 power source
300 actuator
500 control device

1. A wireless power supply unit comprising:
a power transmitting module; and
a power receiving module, wherein,
the power transmitting module includes
a first transmission coil to send out first AC power, and
a second transmission coil to send out second AC power;
the power receiving module includes:
a first reception coil to receive from the first transmission coil at least a portion of the first AC power;
a second reception coil to receive from the second transmission coil at least a portion of the second AC power; and
a compensation circuit connected to the first and second reception coils, the compensation circuit including at least one compensation element to counteract at least a part of a leakage reactance or an excitation reactance of at least one coil pair among:
a first coil pair comprising the first transmission coil and the first reception coil,
a second coil pair comprising the second transmission coil and the second reception coil,
a third coil pair comprising the first transmission coil and the second transmission coil,
a fourth coil pair comprising the first reception coil and the second reception coil,
a fifth coil pair comprising the first transmission coil and the second reception coil, and
a sixth coil pair comprising the second transmission coil and the first reception coil.

2. The wireless power supply unit of claim 1, wherein the compensation circuit includes a plurality of compensation elements to counteract both the excitation reactance and the leakage reactance of the at least one coil pair.

3. The wireless power supply unit of claim 1, wherein the compensation circuit includes a plurality of compensation elements to counteract at least a part of the leakage reactance or the excitation reactance of each of the first to sixth coil pairs.

4. The wireless power supply unit of claim 1, wherein the compensation circuit includes a plurality of compensation elements to counteract both of the leakage reactance and the excitation reactance of each of the first to sixth coil pairs.

5. The wireless power supply unit of claim 2, wherein, when a coupled circuit including a plurality of coils that electromagnetically couple to one another is expressed in a π equivalent circuit, the plurality of coils including the first and second transmission coils and the first and second reception coils, a reactance of each of the plurality of compensation elements is set to a value for counteracting one of a plurality of reactances in the π equivalent circuit.

6. The wireless power supply unit of claim 1, wherein the compensation circuit includes
a first compensation element to counteract at least a part of the leakage reactance of the first coil pair, the first compensation element being connected in series to the first reception coil, and
a second compensation element to counteract at least a part of the leakage reactance of the second coil pair, the second compensation element being connected in series to the second reception coil.

7. The wireless power supply unit of claim 6, wherein,
the power transmitting module includes
a third compensation element connected to the first transmission coil, and
a fourth compensation element connected to the second transmission coil;
the first compensation element and the third compensation element counteract the leakage reactance of the first coil pair; and
the second compensation element and the fourth compensation element counteract the leakage reactance of the second coil pair.

8. The wireless power supply unit of claim 1, wherein the at least one compensation element is a capacitor or an inductor.

9. The wireless power supply unit of claim 1, wherein the power transmitting module includes
a first inverter circuit to supply the first AC power to the first transmission coil,
a second inverter circuit to supply the second AC power to the second transmission coil, and
a control circuit to control the first and second inverter circuits.

10. The wireless power supply unit of claim 9, wherein the control circuit changes voltages to be output from the compensation circuit by changing a phase difference between the first AC power and the second AC power.

11. The wireless power supply unit of claim 1, wherein,
the power transmitting module further includes a third transmission coil to send out third AC power;
the power receiving module further includes a third reception coil to receive from the third transmission coil at least a portion of the third AC power; and
the compensation circuit includes at least one compensation element to counteract at least a part of a leakage reactance or an excitation reactance of a coil pair comprising: one coil among the first and second transmission coils and the first and second reception coils; and the third transmission coil or the third reception coil.

12. A wireless power supply unit comprising:
a power transmitting module; and
a power receiving module, wherein,
the power transmitting module includes a transmission coil to send out AC power; and
the power receiving module includes
a reception coil to receive from the transmission coil at least a portion of the AC power, and
a compensation circuit connected to the reception coil, the compensation circuit including at least one compensation element to counteract at least a part of a leakage reactance or an excitation reactance of a coil pair comprising the transmission coil and the reception coil.

13. The power receiving module for use in a wireless power supply unit, the wireless power supply unit including a power transmitting module and the power receiving module, the power transmitting module including a first transmission coil to send out first AC power and a second transmission coil to send out second AC power, the power receiving module comprising:
a first reception coil to receive from the first transmission coil at least a portion of the first AC power;
a second reception coil to receive from the second transmission coil at least a portion of the second AC power; and
a compensation circuit connected to the first and second reception coils, the compensation circuit including at least one compensation element to counteract at least a part of a leakage reactance or an excitation reactance of at least one coil pair among:
a first coil pair comprising the first transmission coil and the first reception coil,
a second coil pair comprising the second transmission coil and the second reception coil,
a third coil pair comprising the first transmission coil and the second transmission coil,
a fourth coil pair comprising the first reception coil and the second reception coil,
a fifth coil pair comprising the first transmission coil and the second reception coil, and
a sixth coil pair comprising the second transmission coil and the first reception coil.
